(19) United States
(12) Patent Application Publication
(10) Pub. No.: US 2022/0351152 A1
(43) Pub. Date: Nov. 3, 2022

(54) SYSTEM AND METHODS FOR INTELLIGENT MEETING SUGGESTION GENERATION

(71) Applicant: Genpact Luxembourg S.á r.l. II, Luxembourg (LU)

(72) Inventor: Gianni Giacomelli, New York, NY (US)

(21) Appl. No.: 17/584,713

(22) Filed: Jan. 26, 2022

Related U.S. Application Data
(60) Provisional application No. 63/182,570, filed on Apr. 30, 2021.

(51) Int. Cl. G06Q 10/10; G06Q 50/00

(52) U.S. Cl. CPC G06Q 10/1095; G06Q 50/01

(57) ABSTRACT

A method and system for intelligently generating a meeting suggestion and automatically adapting meeting interfaces are disclosed. In some embodiments, the method includes obtaining user relationship data between a first user and a plurality of other users, the user relationship data including first measurements of a first network attribute and second measurements of a second network attribute; receiving user preferences on the first and second network attributes; identifying a set of users as weak-tie connections based on a user preference on the first network attribute and first measurements; filtering the set of users based on the second preference and the second measurements on the second network attribute to determine a second user; automatically determining an available time slot for the first and second users; and presenting to the first user and the second user a suggested meeting with each other at the available time slot.

### CROSS REFERENCE TO RELATED APPLICATION

This application claims the benefit of priority to U.S. Provisional Patent Application No. 63/182,570, filed Apr. 30, 2021, the entire contents of which are incorporated by reference herein.

### TECHNICAL FIELD

This disclosure relates to systems and methods for intelligently generating meeting suggestions and automatically adapting meeting interfaces based at least on diversity, tie strength, and user preferences using machine learning modelling.

### BACKGROUND

Virtual conferencing/meeting allows two or more people at multiple places to communicate with each other through video, audio, and text transmissions in an online meeting, which is particularly useful when a face-to-face meeting is unavailable or burdensome. For example, when many people choose (e.g., based on personal choices) or are forced to (e.g., due to a pandemic) work from home, the ties and collaborations between people, in particular, the weak ties between people who do not connect frequently through some routine forms, are reduced. Because the weak ties foster the creation of new ideas, ensure the passage of new information, and strengthen the culture and belonging in an environment, these ties are essential to the success of companies and people. There is an imminent need to improve these weak ties and widen the networking between the people; however, existing virtual communication tools are unable to improve the weak ties.

In addition, determining when to connect with whom in a virtual meeting itself is challenging when a person has many network connections (e.g., friends, colleagues) and wants to connect with different goals (e.g., social catch-ups, business development, learning purpose). For example, even if a first person has a diverse network, the first person may not easily prioritize and interact with a second person in the far-end of his/her network (e.g., a number of network hops away). Further, there lacks an efficient mechanism that automatically captures dynamic changes of people's networks such as connections, availabilities, etc., and adjusts virtual meeting schedules to adapt to the changes timely.

### SUMMARY

To address the aforementioned shortcomings, a method and a system for intelligently generating a meeting suggestion and automatically adapting meeting interfaces to improve weak-tie connections are provided. The method obtains user relationship data between a first user and a plurality of other users, the user relationship data including first measurements of a first network attribute between the first user and the plurality of other users and second measurements of a second network attribute between the first user and the plurality of other users. The method then generates a first user interface to receive user preferences from the first user, the user preferences including at least a first preference of the first user on the first network attribute and a second preference of the first user on the second network attribute. The method identifies, from the plurality of other users, a set of users as weak-tie connections with the first user based on the first preference and the first measurements of the first network attribute. The method filters the set of users based on the second preference and the second measurements of the second network attribute to determine, from the set of users, a second user to meet with the first user. The method also automatically determines an available time slot for the first and second users. The method further generates a second user interface to present to the first user and the second user a suggested meeting with each other at the available time slot.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 illustrates an exemplary high-level process for intelligently generating meeting suggestions and automatically adapting meeting interfaces, according to some embodiments.

FIG. 2 illustrates an exemplary user interface of a meeting suggestion, according to some embodiments.

FIG. 3 is a system for intelligently generating meeting suggestions and automatically adapting meeting interfaces, according to some embodiments.

FIG. 4 is a server used as part of a system for generating meeting suggestions using the methods described herein, according to some embodiments.

FIG. 5 illustrates an example procedure for intelligently generating meeting suggestions, according to some embodiments.

FIG. 6A illustrates a table listing example preferences available to a user, according to some embodiments.

FIG. 6B illustrates an example calendaring interface, according to some embodiments.

FIGS. 7A-7K illustrate exemplary user interfaces of a meeting suggestion generation process, according to some embodiments.

FIGS. 8A and 8B illustrate exemplary user interfaces related to a “Coffee with me” feature of a connect bot solution.

FIG. 9 illustrates an exemplary method for intelligently generating a meeting suggestion for a first user and another user, according to some embodiments.

FIG. 10 illustrates an exemplary method for intelligently generating a meeting suggestion for a user, according to some embodiments.

### DETAILED DESCRIPTION

The Figures (Figs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

The present disclosure provides systems and methods for intelligently generating meeting suggestions and automatically adapting meeting interfaces to connect users among different networks. In some embodiments, the present disclosure may enable a process such that users (e.g., employees) are connected with each other through virtual meetings based on measurements of proximity, diversity, and network centrality as well as user preferences (e.g., on frequency and diversity). The present disclosure may improve ties/relationships between the users and widen user networks by integrating a bot experience (e.g., bot application) with a video conferencing solution (e.g., MS Teams®, Zoom®, Webex®). The present disclosure may further use machine learning (ML) modelling to determine and adjust values of parameters/attributes used in connecting the users via virtual meetings.

Currently, social network systems may provide connection suggestions to users, but not integrate with virtual conference systems to allow a user to schedule virtual meetings with the suggested connections. Even if some current social network systems and virtual conference systems are able to integrate to some extent, no user preferences, in particular, preferences on diversity or proximity, are taken into account when generating a meeting suggestion for a user. A user may be assigned a meeting at an available timeslot while the user actually prefers a meeting with a different person having a different diversity at another available timeslot. Since user preferences vary over time and in different situations, currently there is no way to provide and update a meeting suggestion that reflects the changes of user preferences. A user may not be able to move away from a series of meetings on a topic when he is losing interest in this topic. Advantageously, the present disclosure provides a technical solution that allows users to virtually meet based on proximity, diversity, and network centrality as well as user preferences (e.g., on frequency and diversity).

Advantageously, the present disclosure provides a collaborative tool (e.g., a workplace platform) for customizing and automatically establishing meetings between users (e.g., employees). Based on a simple activation of this tool on an associated device, a user can connect with others (e.g., co-workers or acquaintance) without working hard on building ties and diversities with the others. Specifically, the present disclosure may improve weak ties between users (e.g., acquaintances) that have lower trust barriers between each other and allow the users to access unique information. The weak ties often provide the users access to unique information because these ties bridge diverse groups such that group members can disseminate and access information that they might not otherwise have access to.

It is also advantageous that the present disclosure models the attributes of ties/relationships (e.g., proximity, diversity, and network centrality) to generate meeting suggestions (e.g., a “matched” meeting) for a user. The disclosed model may take advantage of each user's network (e.g., long connections list of each user, overlaps/non-overlaps between each user's network), rich interaction histories between users, and user calendar events to customize and generate appropriate meeting suggestions for a user. In this way, the disclosed model automatically captures and leverages user information in meeting suggestion generation, and thus overcomes the problem of retrospective informant accuracy. That is, no unreliable information recall is needed from a user. For example, a user does not need to remember what friends are in his/her network and whether they are available for a meeting.

In addition, the tie strength/proximity, diversity, and network centrality disclosed herein are measured with continuous values or scores rather than scaled in discrete levels. This continuum lends the measurements to standard modeling techniques to use well-developed algorithms to train model(s) to prioritize via tie strength, diversity, and network centrality, etc. Such a model incorporating continuous tie attributes as well as allowing users to tune parameters will likely provide more useful, timely, and confident meeting suggestion results.

Advantageously, the present disclosure provides a technical solution that is continuously retrained and enhanced (e.g., based on user feedback) to increase the accuracy and efficiency of meeting suggestion generation. The technical solution described herein captures the change or variations of user behaviors (e.g., user preferences) over time and retrains the models with the captured changes, while this is infeasible in current systems. While a user can set up the preferences, some contexts detected from user behaviors will also affect the generated meeting suggestions over time. For example, a positive or negative feedback to a meeting suggestion or a simple click of declining or accepting the meeting suggestion can be used to increase or decrease a similar type of meeting suggestion in future meeting arrangements. If a user keeps declining meetings at noon, the system will no longer generate a meeting suggestion around noon even if the user preference shows the noon is available for the user.

In addition to the meeting suggestions with other users, advantageously, the present disclosure may also determine and suggest a “self” meeting for a user, that is, reserving a time slot of a special appointment (e.g., learning on a user-selected subject) for a user, per user preferences. This increases system flexibility and helps users' time management.

The present disclosure also improves user interfaces. The technical solution disclosed herein generates and displays different user interfaces such as a meeting reminder or a matching list for incoming meetings in a visually attractive manner (e.g., suppressing other visual displays relevant to other events/users). As a result, one glance at a meeting interface would allow a user to view the preferences, recognize with whom and at what time the user will meet, etc. Accordingly, the technical benefits of the technical solution described herein include saving computing resources (e.g., processing time, memory) and network resources (e.g., network traffic, bandwidth) otherwise spent on searching and finding a matched meeting. Especially when a user uses small screen devices for configuring preferences or joining a meeting, no navigation or drill-down to layers of menus or interfaces is needed, which significantly improves user interfaces as well as user experience.

### Overall Meeting Suggestion Generation

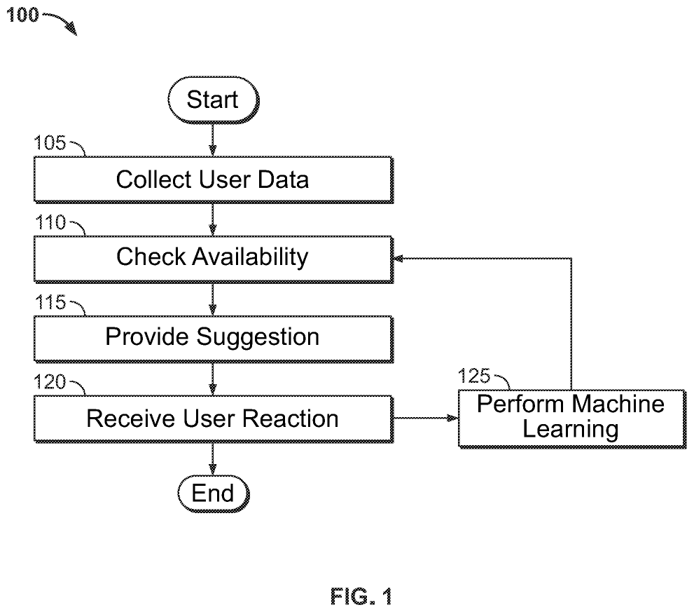

FIG. 1 illustrates an exemplary high-level process 100 for intelligently generating meeting suggestions and automatically adapting meeting interfaces, according to some embodiments. Advantageously, the present disclosure provides meeting suggestions to improve the network ties among users (e.g., employees). The present disclosure also monitors and tracks user feedback regarding the provided suggestions to generate analytics and use the analytics to improve meeting suggestions. The user feedback may include at least a number of meetings declined or accepted by users.

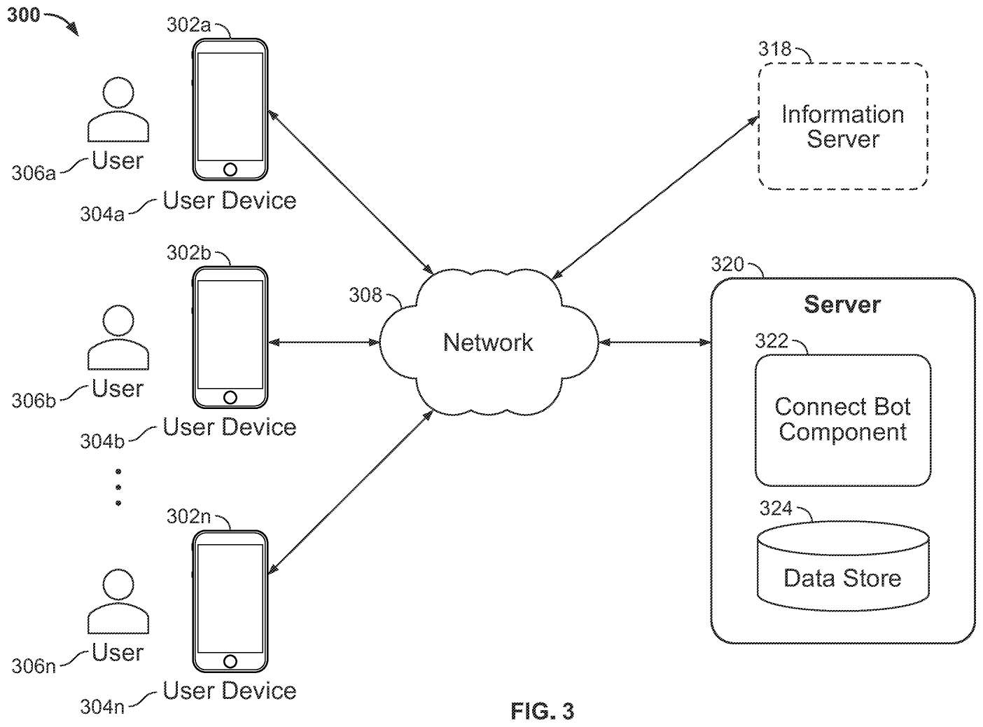

At the first operation 105 of FIG. 1, user data are collected and analyzed. In an enterprise environment, users may be employees of one or more organizations, and at least a portion of user data associated with the users may be retrieved from an enterprise resource planning (ERP) system and/or other source server(s) that communicates with the ERP system. An ERP system may manage and integrate an organization's financials, supply chain, operations, commerce, reporting, manufacturing, and human resource activities, while an example source server may be a server executing Microsoft Office® 365 application. At operation 105, at least user relationship data is collected from the ERP and/or other source server(s). The user relationship data may include different measurements, e.g., proximity, diversity, network centrality, etc., of a type of user relationship between users. The user data may also include user input data such as user preferences, user reaction, and other types of data entered by the user. In some embodiments, the user input data includes data entered by the user via a bot application executing on a user device associated with the user. The bot application is a user-end application that communicates with server(s) and other user devices to implement the functionalities described herein. The bot application or a connect bot will be described below with reference to FIGS. 3, 7A-7K, and 8A-8B. While the description herein is mainly focused on an enterprise environment, a person skilled in the art should recognize that the users can be any types of users other than users/employees in an enterprise environment, and the approach to intelligently generate meeting suggestions described herein can be easily and similarly applied to other environments using the user data associated with other types of users.

At operation 110, user availability is checked. In some embodiments, a user calendar (e.g., Microsoft Outlook® calendar, Google® Calendar) associated with a user may be accessed, and the event data recorded in the calendar may be used, based on user preferences, to determine whether the user is available for a meeting in a specific time slot. For example, if a time slot in the calendar is empty and the user references do not put any restrictions on the use of this slot, this time slot may then be used to schedule a virtual meeting between the user and at least one selected meeting participant.

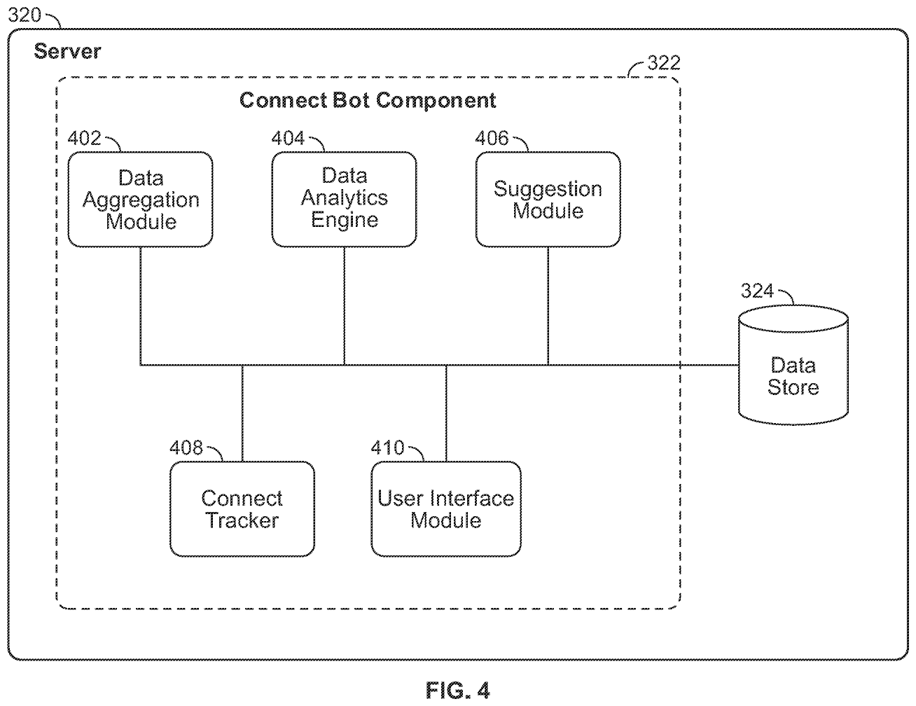

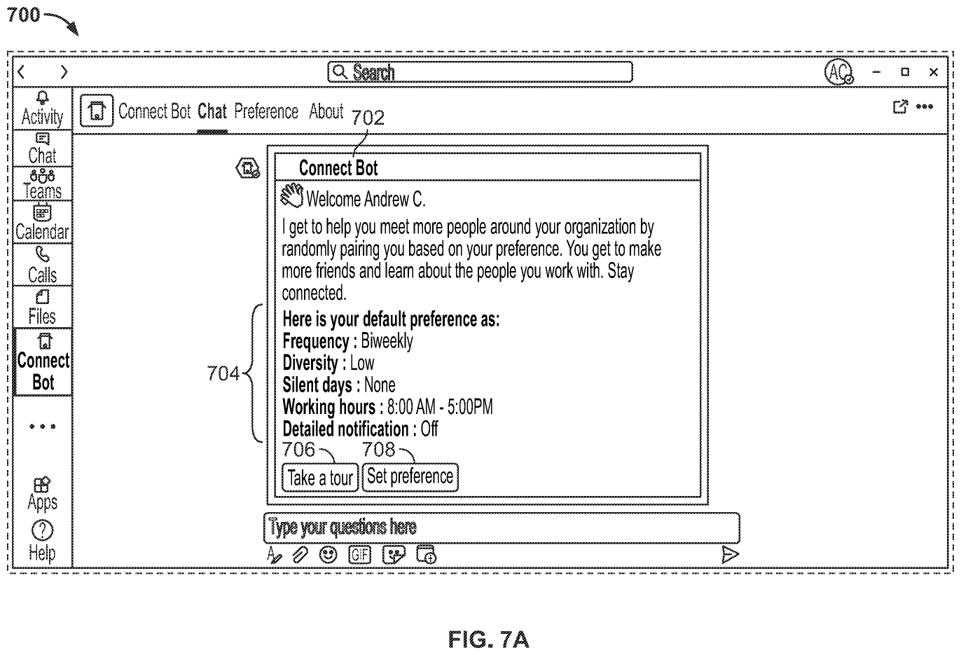

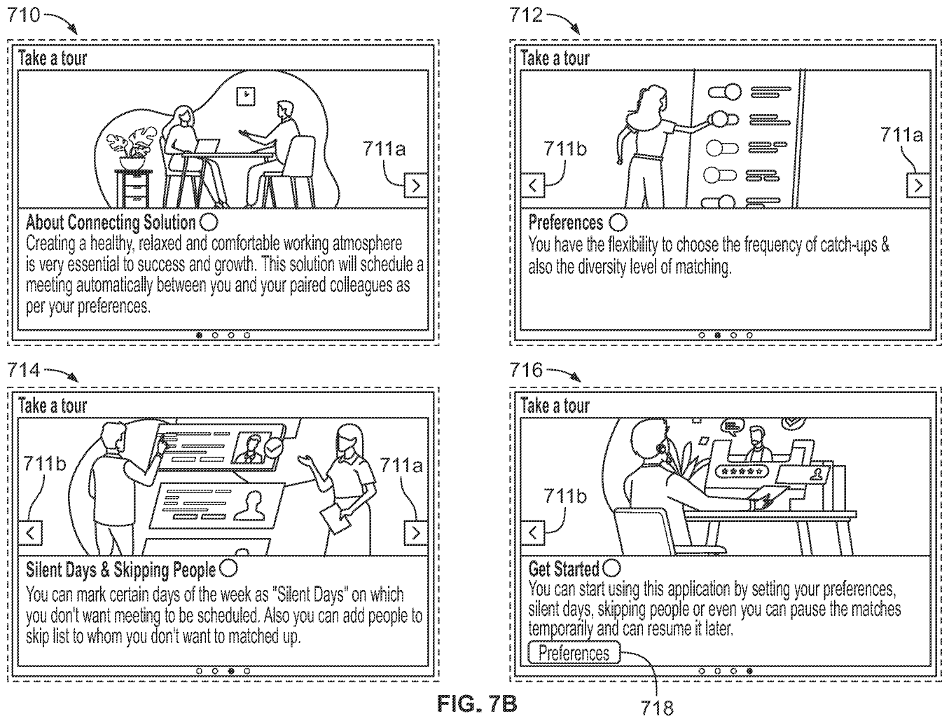

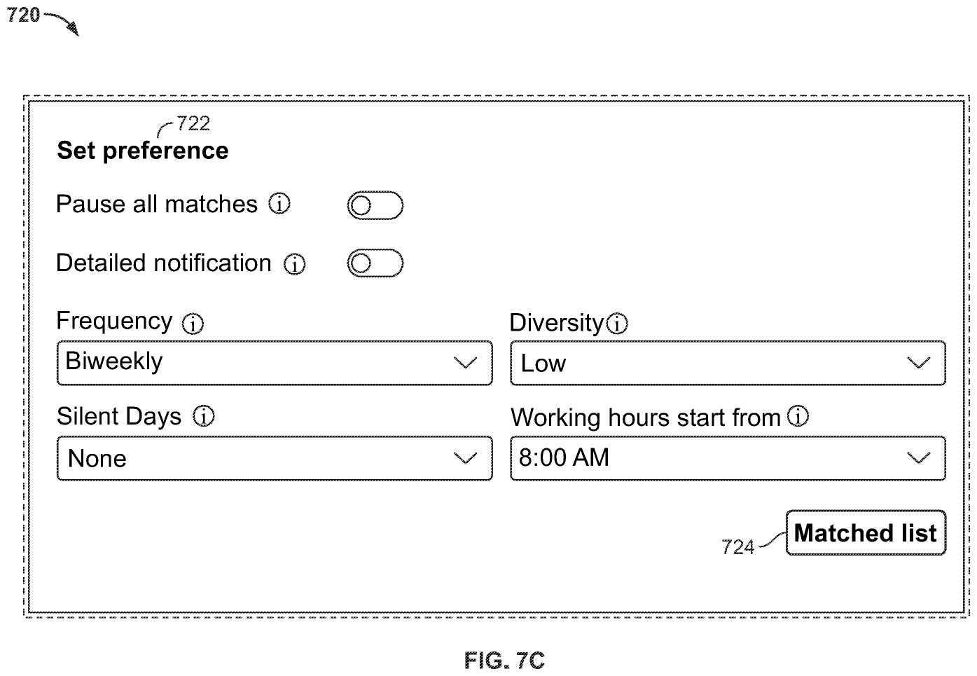

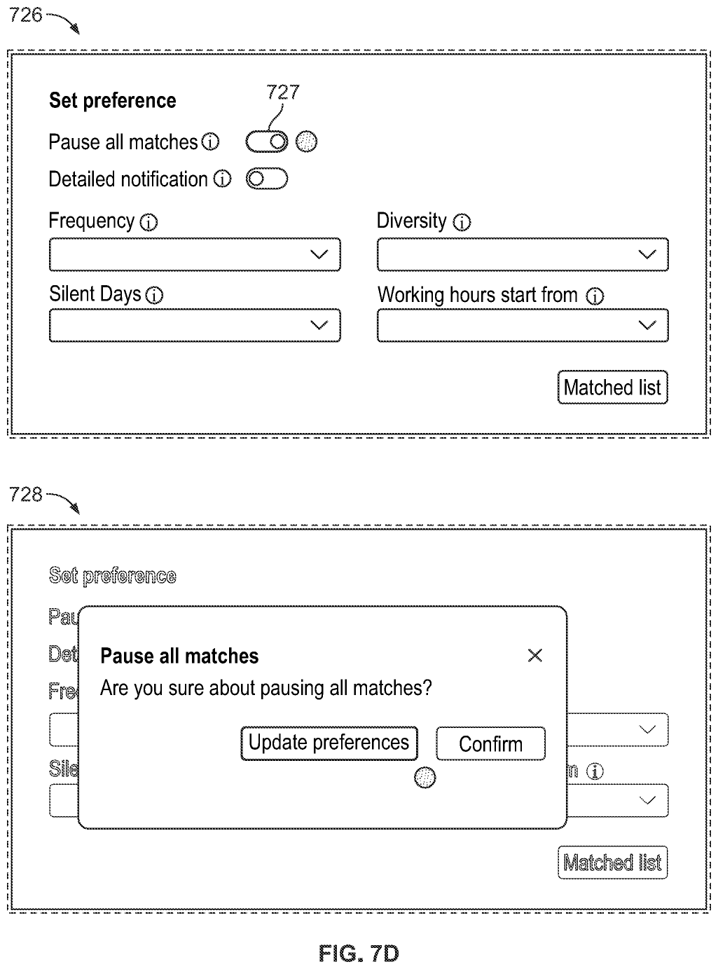

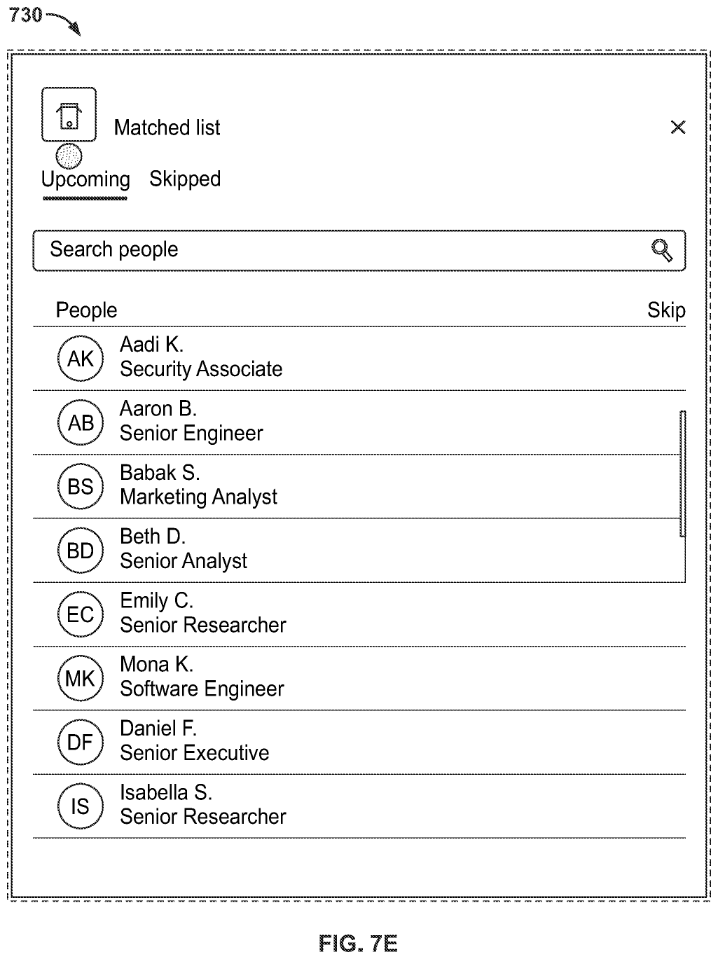

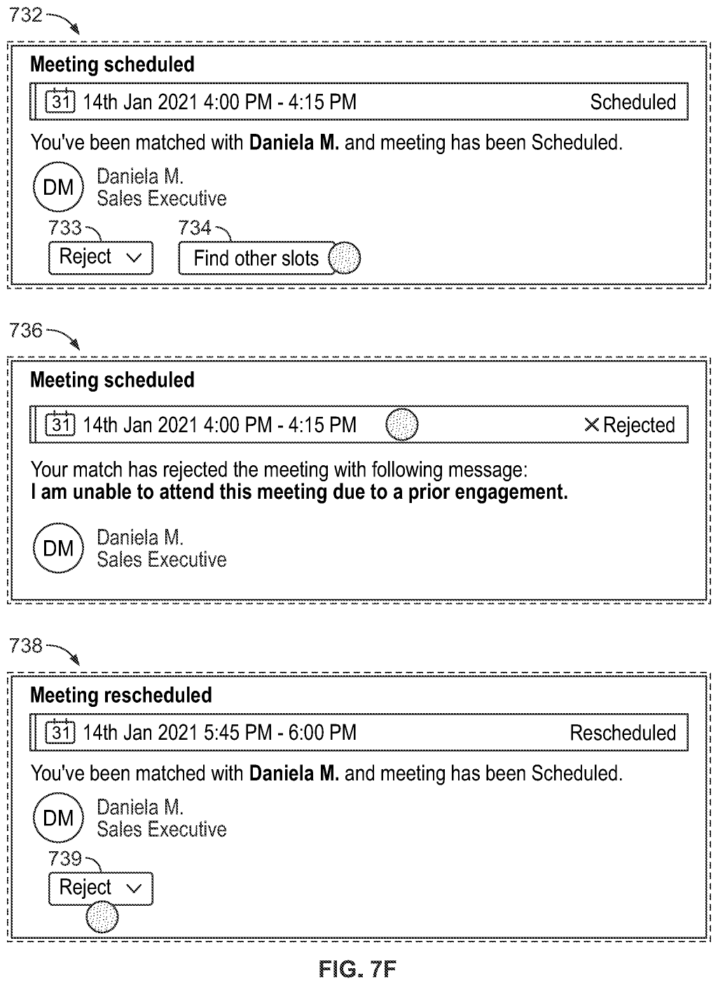

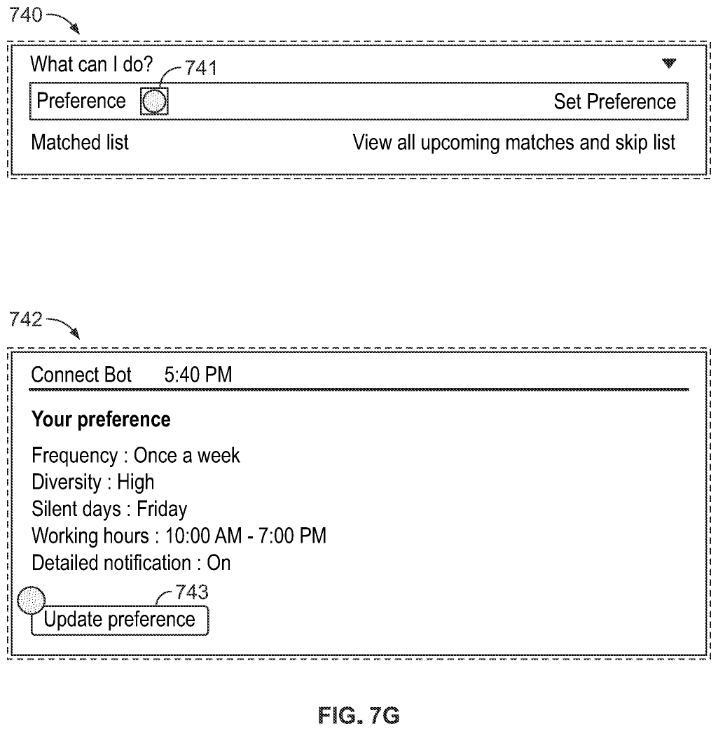

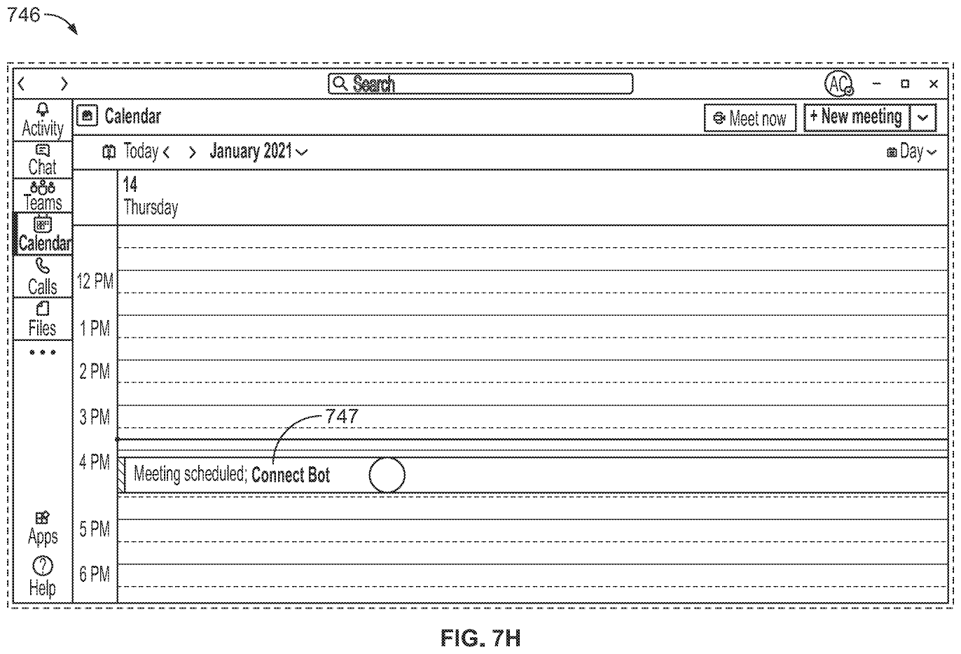

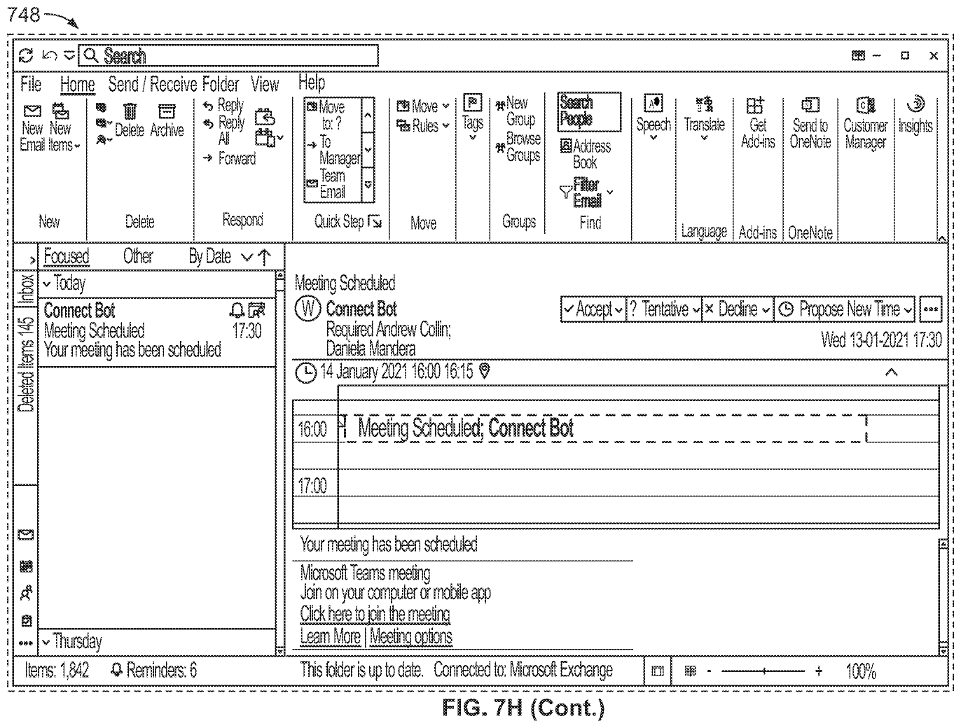

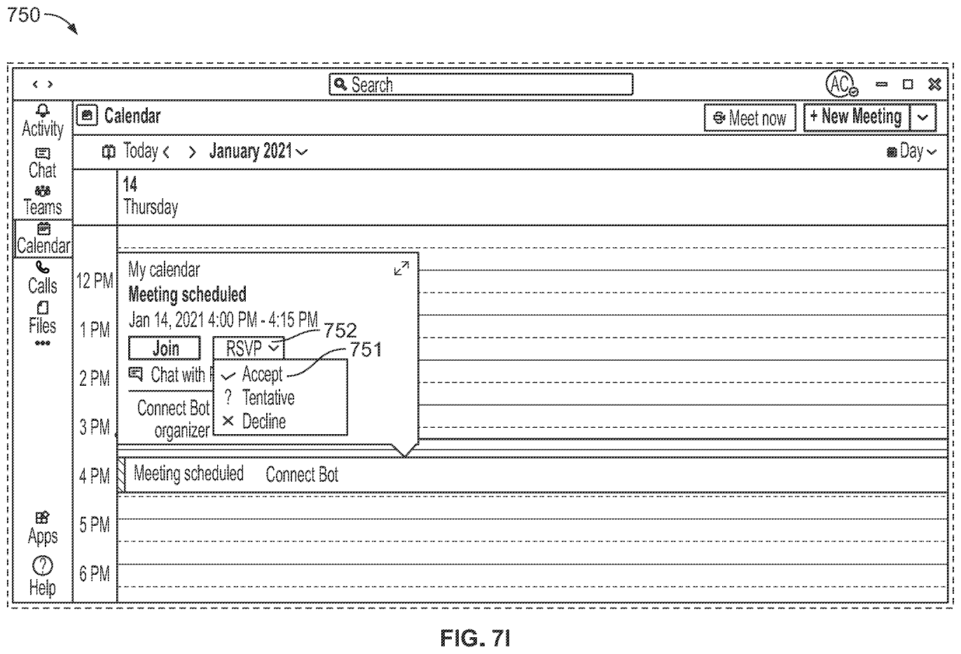

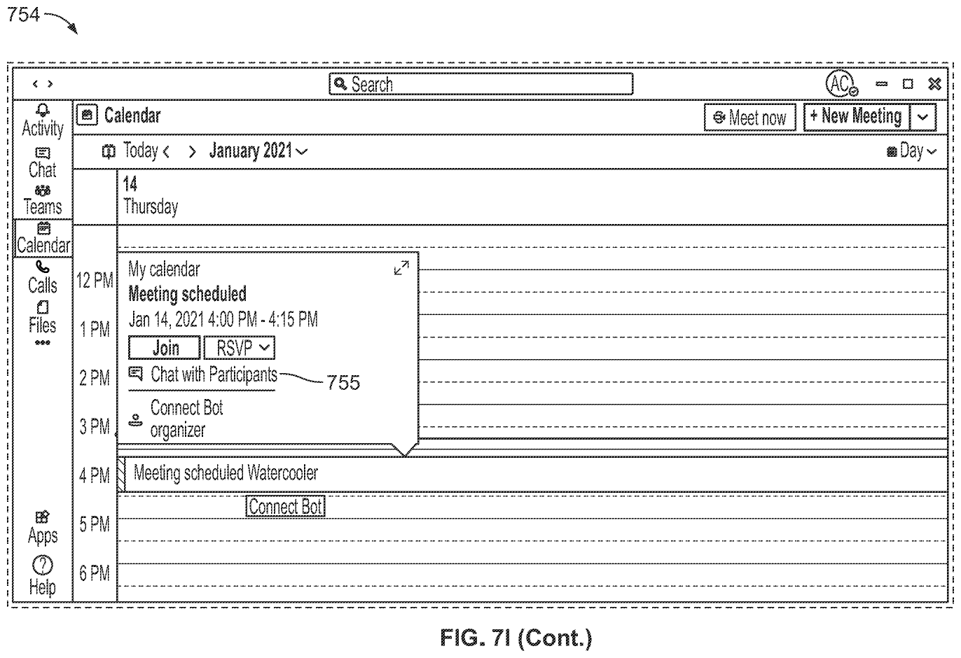

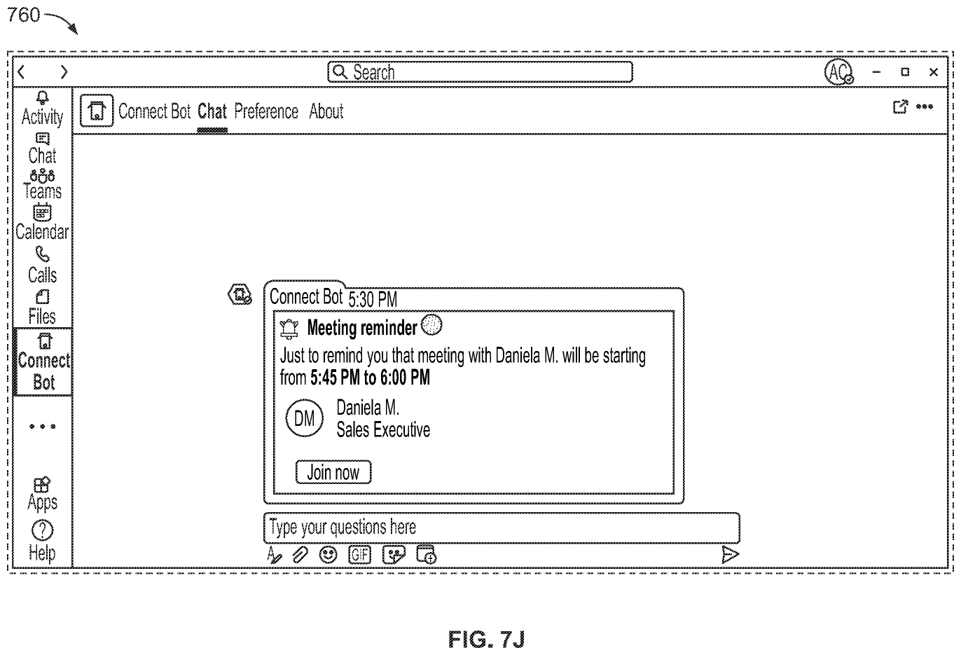

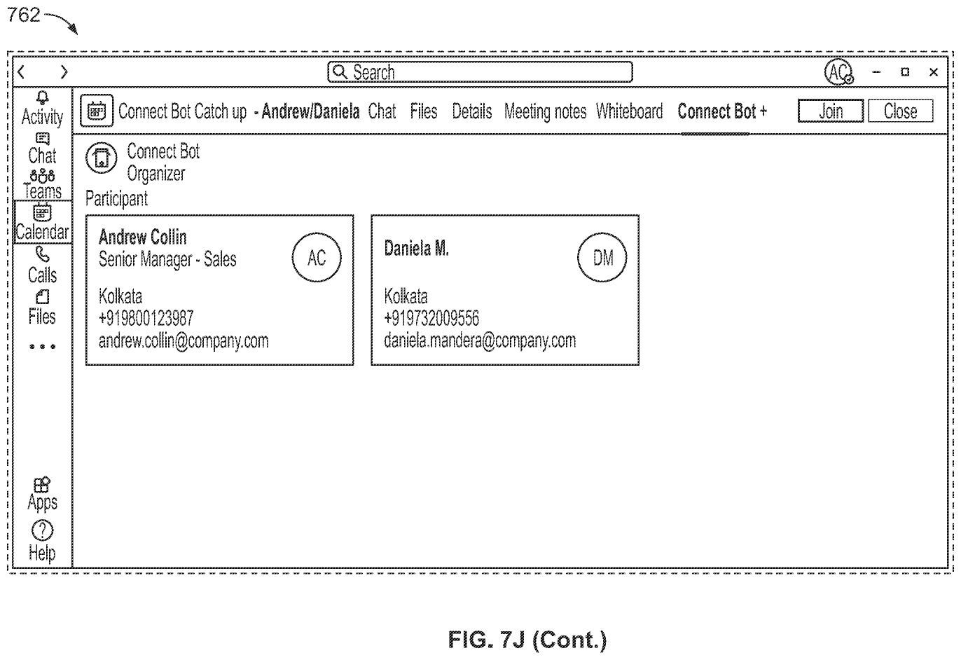

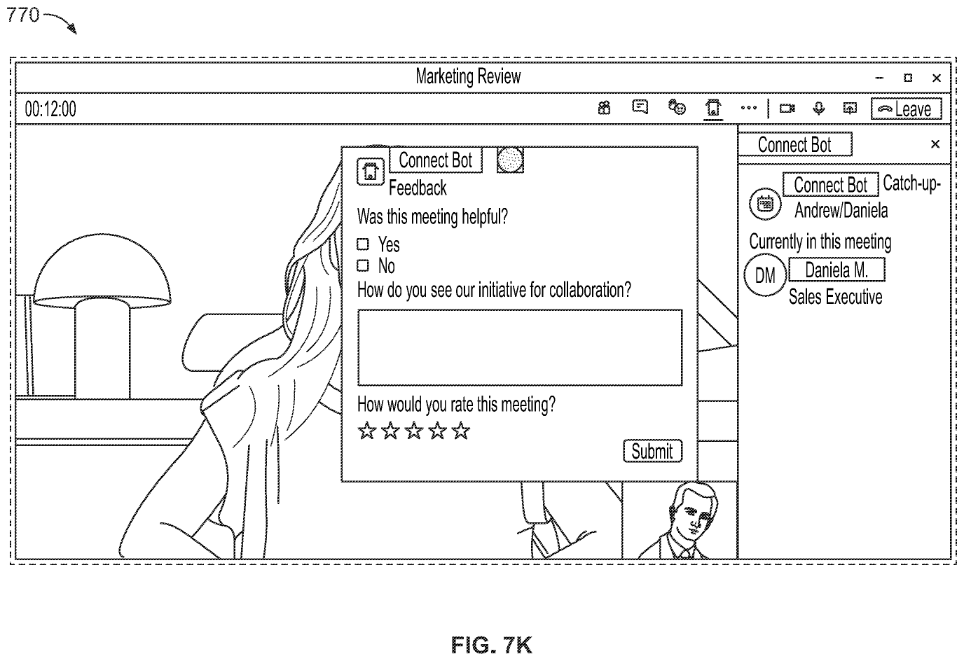

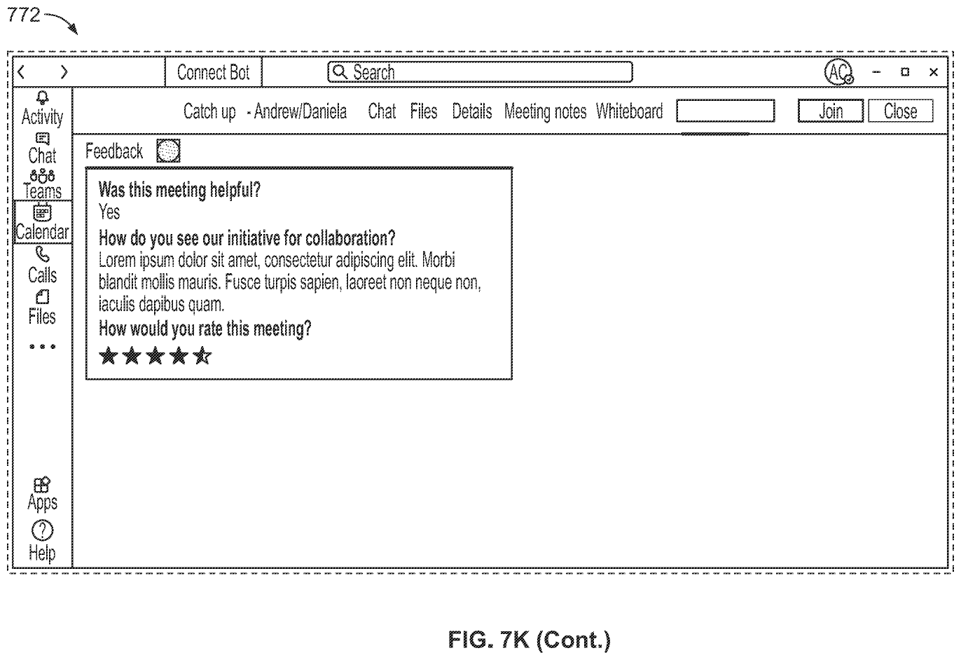

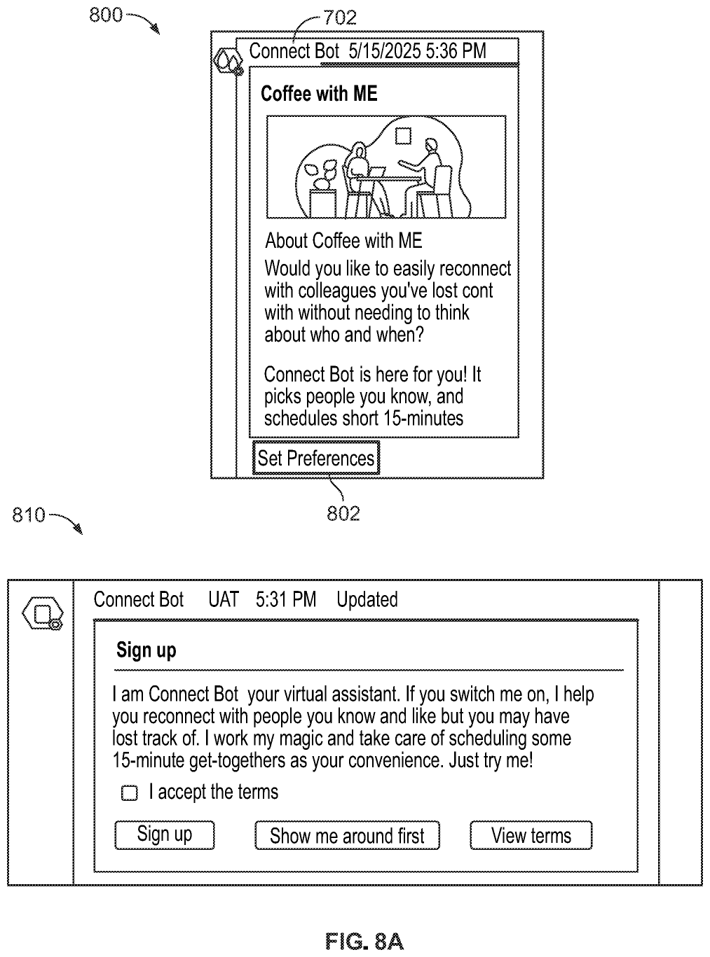

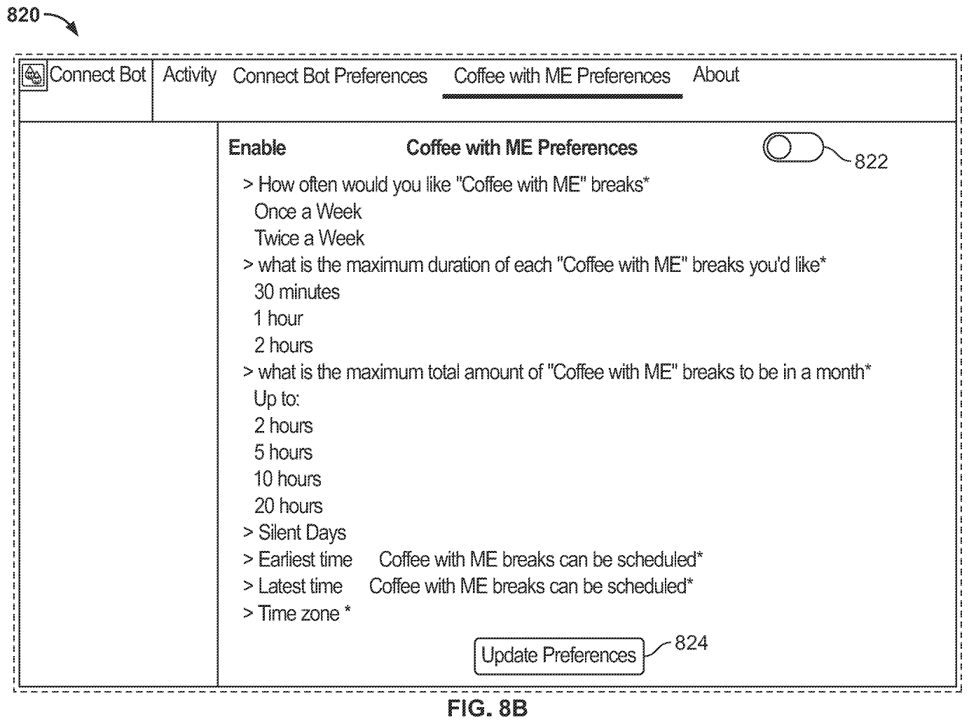

At operation 115, one or more meeting suggestions are provided to the user based on the collected user data and user availability. For example, depending on different levels of diversities configured by a user in user preferences settings and user availabilities determined from user calendar events, different meetings with different users at different time slots may be suggested to the user. In some embodiments, the meeting suggestion may also be a single user appointment determined per user preferences, for example, a “coffee with me” break as shown in FIGS. 8A and 8B. At operation 120, the user may provide a user reaction to the suggested meetings. The user reaction can be a decline or acceptance of a suggested meeting, a request for rescheduling a meeting, a user comment related to the suggested meeting, or any other types of actions implicitly or explicitly expressing user feedback to the suggested meeting. In particular, the user has the abilility to stop or enable a meeting at an individual level. For example, a user can be provided a meeting list (e.g., via a “Your Matches” tab from a “prefercence” option to obtain a user interface as shown in FIG. 7E), and de-select an entry or name from the meeting list to stop a corresponding meeting. The provision of meeting suggestions and feedback identification will be described below in detail with reference to FIGS. 4, 5, and 7A-8B.

In some embodiments, the present disclosure can also use an ML mechanism at operation 125 to detect the user reaction or feedback and use the detected feedback to train one or more ML models. For example, a user may have met a new hire in several offline situations, and so, the user may want to leave the virtual meeting opportunities to network connections (e.g., enterprise employees) other than the new hire. The ML mechanism may learn from the user reaction and cause the new hire to be removed from a list of high diversity members, and as a result, the user can receive meeting suggestions with other qualified high diversity members. Hence, the meeting suggestions are promoted and the user experience is improved. In contrast, in existing systems, one or more of detecting the feedback and variation/parameters, circulating newly detected data into ML models, and retraining the models are manually performed (e.g., by an analyst). It should be noted FIG. 1 is merely an exemplary illustration of an intelligent meeting suggestion generation process, operations may be added and/or removed within the spirit and the scope of this disclosure.

It should also be noted that the algorithms and processes described herein may anonymize private or sensitive information to protect information security and data privacy. For example, the present disclosure herein may anonymize the personally identifiable information (PII), which is the information, when used alone or with other relevant data, can identify an individual. The present disclosure herein may also anonymize sensitive personally identifiable information such as a full name, a social security number, financial information, etc.

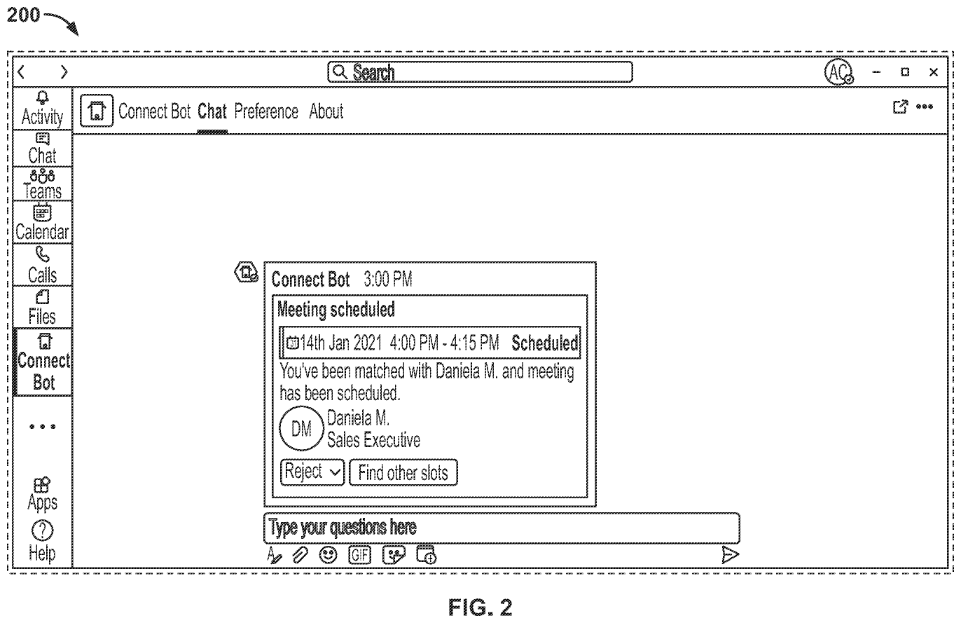

FIG. 2 shows an exemplary user interface 200 of a meeting suggestion, according to some embodiments. In some embodiments, once the operations in FIG. 1 are performed, one or more meeting suggestions are provided to a user as shown in the meeting notification of FIG. 2. In the example of FIG. 2, the user is notified that she/he will have a meeting with Daniela M. at 4:00 PM-4:15 PM on Jan. 14, 2021. The user can choose to reject this meeting or find other slots for this meeting. User interface 200 is merely one of a number of user interfaces generated and provided by the present disclosure to facilitate the communication between users. More user interfaces will be described below in FIGS. 7A-7K and 8A-8B.

### Computer Implementation

FIG. 3 is a system 300 for intelligently generating meeting suggestions and automatically adapting meeting interfaces, according to some embodiments. By way of example and not limitation, the methods described herein (e.g., process 100 in FIG. 1) may be executed, at least in part, by a software application 302a, 302b . . . 302n respectively running on user device 304a, 304b . . . 304n. The user device 304a, 304b . . . 304n is respectively operated by a user 306a, 306b . . . 306n. In the description hereafter, each collective numeral such as 302, 304, and 306 may be used to represent similar individual numbers. For example, user 306a, 306b . . . 306n may be collectively referred to as 306.

By way of example and not limitation, user device 304 can be a smartphone device, a tablet, a tablet personal computer (PC), or a laptop PC. In some embodiments, user device 304 can be any suitable electronic device connected to a network 308 via a wired or wireless connection and capable of running software applications like software application 302. In some embodiments, user device 304 can be a desktop PC running software application 302. In some embodiments, software application 302 can be installed on user device 304 or be a web-based application running on user device 304. By way of example and not limitation, user 306 can be a person that intends to virtually meet with other people or a person that plans a self-project at an available time slot. The user can communicate with server 320 via software application 302 residing on user device 304 to receive one or more meeting suggestions that satisfy his/her specific preferences. For example, user 306a may be notified to meet with user 306n at a given time based on the preferences of both users 306a and 306n. In some embodiments, software application 302 can be a bot application that integrates with a video conferencing solution (e.g., Microsoft Teams®, Zoom®, Webex®, etc.) to provide a virtual meeting platform via user device 304 for user 306.

Network 308 can be an intranet network, an extranet network, a public network, or combinations thereof used by software application 302 to exchange information with one or more remote or local servers, such as information server 318 or server 320. According to some embodiments, software application 302 can be configured to exchange information, via network 308, with additional servers that belong to system 300 or other systems similar to system 300 not shown in FIG. 3 for simplicity.

In some embodiments, server 320 is configured to store, process and analyze the information received from user 306 (e.g., via software application 302) and/or from information server 318 (e.g., ERP server), and subsequently transmit in real-time processed data back to software application 302. Server 320 can include a connect bot component 322 and a data store 324, which each includes a number of modules and components discussed below with reference to FIG. 4. Connect bot component 322 can communicate with user devices 304 and/or information server 318 to obtain user data, and generate and provide a meeting suggestion to a user based on analyzing the obtained data. For example, connect bot component 322 can obtain user data (e.g., user preferences, user calendar data) via software application 302 and obtain user relationship data (e.g., proximity, diversity, user networking/connection data) from information server 318. Connect bot component 322 can further communicate a backend virtual meeting solution (not shown) to provide a virtual meeting platform for users to conduct the suggested meeting. According to some embodiments, server 320 performs at least some of the operations discussed in the methods described herein (e.g., process 100 in FIG. 1). In some embodiments, server 320 can be a cloud-based server. In some embodiments, server 320 can also perform at least some of the functionalities of an information server, and information server 318 depicted in a dash-lined box may be optional.

In some embodiments, FIG. 4 depicts selective components of server 320 used to perform the functionalities described herein, for example, operations of process 100. Server 320 may include additional components not shown in FIG. 4. These additional components are omitted merely for simplicity. These additional components may include, but are not limited to, computer processing units (CPUs), graphical processing units (GPUs), memory banks, graphic adaptors, external ports and connections, peripherals, power supplies, etc., required for the operation of server 320. The aforementioned additional components, and other components, required for the operation of server 320 are within the spirit and the scope of this disclosure.

In the illustrated embodiment of FIG. 4, server 320 includes a connect bot component 322 and a data store 324. Connect bot component 322 in turn includes one or more modules/engines responsible for processing and analyzing the information received by server 320. For example, the modules/engines in connect bot component 322 may have access to user calendar events and user preferences from user 306, and generate a meeting suggestion.

In some embodiments, connect bot component 322 of server 320 includes a data aggregation module 402, a data analytics engine 404, a suggestion module 406, a connect tracker 408, and a user interface module 410. In some embodiments, connect bot component 322 of server 320 may include only a subset of the aforementioned modules or include at least one of the aforementioned modules. Additional modules may be present on other servers communicatively coupled to server 320. For example, user interface module 410 may be deployed on separate servers (including server 320) that are communicatively coupled to each other. All possible permutations and combinations, including the ones described above, are within the spirit and the scope of this disclosure.

In some embodiments, each module/engine of connect bot component 322 may store the data used and generated in performing the functionalities described herein in data store 324. Data store 324 may be categorized in different libraries (not shown). Each library stores one or more types of data used in implementing the methods described herein. By way of example and not limitation, each library can be a hard disk drive (HDD), a solid-state drive (SSD), a memory bank, or another suitable storage medium to which other components of server 320 have read and write access.

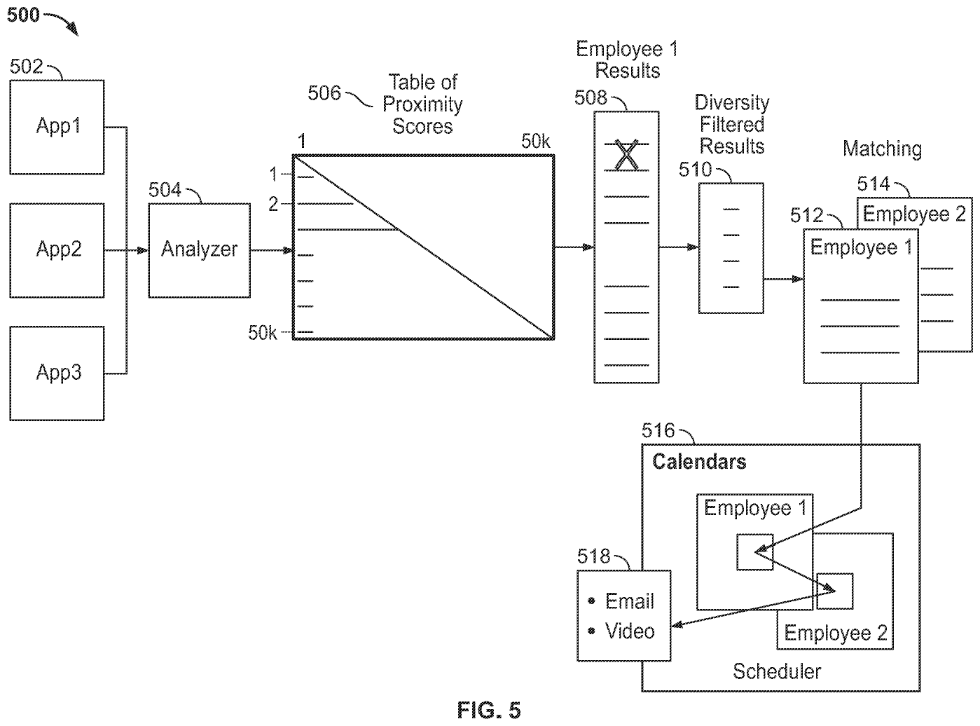

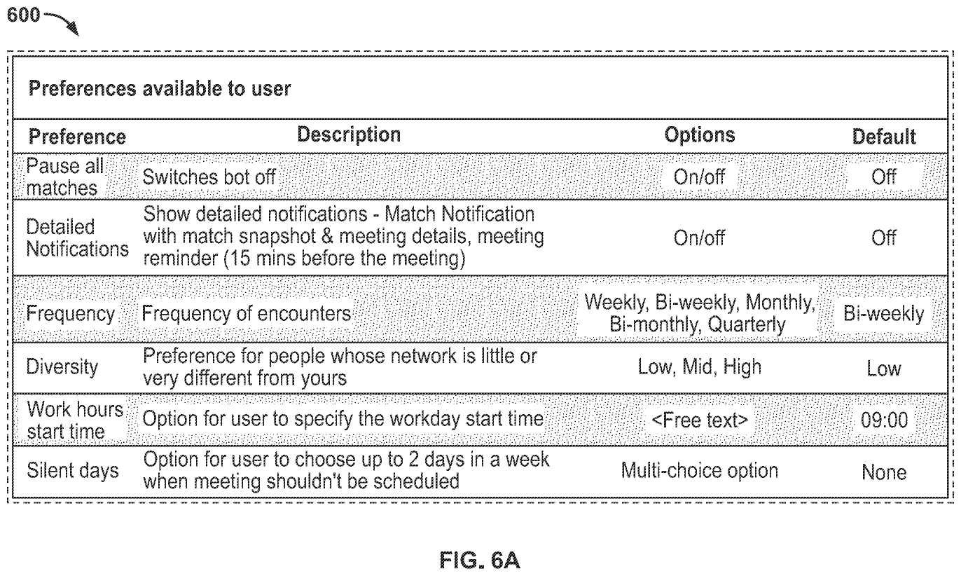

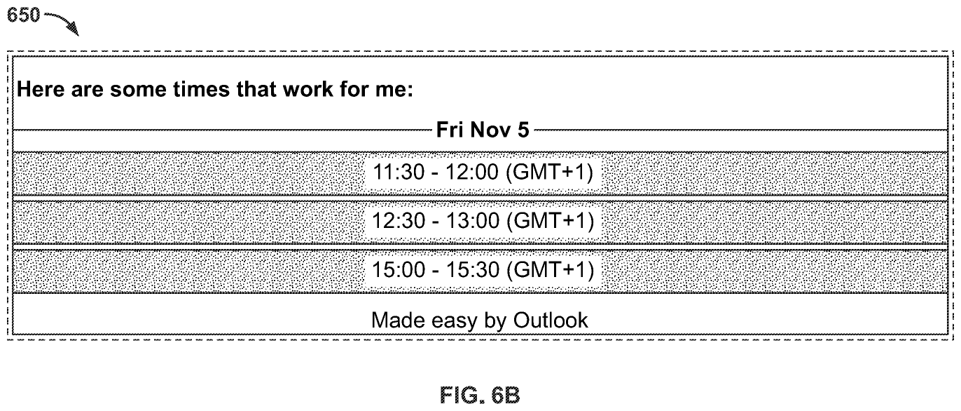

For simplicity and clarity, various functionalities performed by connect bot component 322 of server 320 in communication with user device 304 as well as other components of system 300 will mainly be described in accordance with the architecture shown in FIG. 5 and with reference to other FIGS. 6A-10.

### Meeting Suggestion Generation

FIG. 5 illustrates an example procedure 500 for intelligently generating meeting suggestions, according to some embodiments. In some embodiments, the meeting suggestions are provided to improve network ties among users based on network relationship attributes (e.g., proximity, diversity, network centrality), user preferences, and/or user availability.

Data aggregation module 402 detects and obtains user data associated with users (e.g., employees) in one or more networks (e.g., an enterprise, an organization). In some embodiments, the user data includes at least personal data received from user device 304 and measurements received from information server 318 (e.g., an ERP server).

In some embodiments, data aggregation module 402 communicates with user device 304 via software application 302 to collect personal data of user 306 such as user demographical data, user preference data, etc. The user demographical data includes at least user name, user location, user interests, etc. The user preference data includes at least the frequency that a user would like to have meetings (e.g., meeting frequency), the diversity of people with whom user 306 wishes to meet (e.g., diversity level), days at which the user chooses not to meet with people (e.g., silent days), or other choices for other meeting attributes. Typically, data aggregation module 402 can communicate with software application 302 executing on user device 304 to cause one or more user interfaces to be generated and presented on user device 304. User 306 can interact with the user interfaces to provide the user demographical data, user preference data, or other types of data required for generating a personalized meeting suggestion to user 306. FIG. 6A illustrates table 600 listing example preferences available to a user. The user may configure the preferences using one or more user interfaces as described in FIGS. 7C-7H and 8A-8B.

In some embodiments, software application 302 is a bot application that integrates and/or builds in a virtual meeting platform to provide enterprise-level conversational artificial intelligence (AI) experience for users. In some embodiments, user 306 is notified to install software application 302 on user device 304 such that software application 302 executing on user device 304 can enable or activate the meeting suggestion generation process described herein. An example connect-bot application/solution, along with user interfaces adapted to the connect-bot application and used to implement the meeting suggestion generation process, will be described below in FIGS. 7A-7K and 8A-8B.

In addition to user preferences and demographical data from user device 304, data aggregation module 402 also fetches measurements from information server 318. In some embodiments, information server 318 may receive user activity/networking data from heterogenous sources and calculate the measurements of user relationships between users based on the received activity data. In some embodiments, information server 318 is a server separate from server 320. In other embodiments, server 320 performs functionalities of information server 318.

As depicted in FIG. 5, in some embodiments, data aggregation module 402 may receive data from heterogenous sources, for example, a number of applications 502. An application 502 may be a Microsoft Office 365 application such as Outlook®, Teams®, etc. Application 502 may also be a social network application such as LinkedIn®, Xing®, etc. A person skilled in the art should recognize that application 502 can be any type of application from which networking or activity data for determining relationships among users can be obtained.

An analyzer 504 receives user activity/networking data from applications 502 and calculates the measurements of user relationships among users. In some embodiments, Analyzer 504 is a part of data analytics engine 404. In other embodiments, Analyzer 504 is on a separate information server 318. Analyzer 504 may monitor user activities across applications and networks and build a collaboration platform for increasing user/employee communications and enhancing workplace performance. For example, when dealing with Microsoft applications, Analyzer 504 may include a Workplace Analytics (WPA) or Microsoft Viva Insights® to collect data (e.g., Microsoft Office 365® graph data) to determine patterns in productivity, effectiveness and engagement in workplace activities. Based on collecting activity data, WPA may create actionable tasks, use custom reports and dashboards to monitor new activity patterns, generate insights to drive changes (e.g., increasing focus time, reducing meeting load), etc.

Analyzer 504 may provide extensive information by capturing user activity data generated during its execution. In some embodiments, Analyzer 504 generates one or more measurements of proximity, diversity, or network centrality based on the data received from different sources such as Microsoft Office® 365 applications or other social network applications. These measurements along with other user data such as preferences and availability will be used to automatically determine a virtual meeting schedule.

Analyzer 504 generates a proximity score that quantifies the strength of a tie/relationship between users. In some embodiments, the proximity score or tie strength is a continuous measurement of closeness in a relationship, ranging from no tie, weak tie to strong tie. A strong tie is a relationship to people with whom an individual has strong trust and frequent interactions. A weak tie is a relationship between acquaintances that have lower trust barriers between them. No tie indicates that two users neither meet each other nor have any mutual connections between them. In some embodiments, Analyzer 504 calculates the proximity score based on a frequency of user interactions, recency of interactions, amount of time of interactions, communication reciprocity (e.g., one-way or two-way interactions), a number of mutual connections (e.g., mutual friends), etc.

Analyzer 504 also generates a diversity score that measures a diversity level between users. Each user has his/her own network including his/her connections (e.g., colleagues, friends, family). The connections or members in a user's network have some common attributes or commit common actions. A first user's network and a second user's network may have someone in common with each other, that is, have common connections or network overlap. A diversity score relates to the extent of network overlap of a user and, in its nature, captures the lack of redundancy in the network connections. In other words, if a network overlap between two users is larger or the number of common connections between two users' networks is higher, the diversity score is lower, and vice versa.

Every user may directly connect or indirectly connect (e.g., via intermediate user) with other users in their networks. In some embodiments, Analyzer 504 further generates a centrality score to measure whether the user is more central than others. For example, for two users having a same amount of connections in their respective network, Analyzer 504 may determine a higher centrality score for the user having a larger number of direct connections. In contrast, Analyzer 504 may determine that a new hire in an enterprise has the least centrality and thus assign a low centrality score.

To generate a personalized meeting, a user may provide and adjust (e.g., via user interfaces) the preferences with respect to proximity, diversity, and centrality. For example, a user may choose to set up a higher diversity level to receive meeting suggestions for persons with whom the user has less in common (e.g., different departments within an organization). In some embodiments, Analyzer 504 may transmit the scores or scoring data to data analytics engine 404 for further processing. Analyzer 504 may also store the scores in data store 324 (e.g., Azure storage).

Data analytics engine 404 intelligently selects and dynamically adjusts one or more meeting participants paired with a user (e.g., user 306) based on scoring data (e.g., proximity, diversity, or centrality) and user preferences. The present disclosure provides a platform for automatically connecting users with each other based on their preferences/interests, which is particularly useful in a workplace environment. Strong ties between employees (e.g., team members) are valuable because they can share information, update working status, and make any direct communications. However, weak ties between acquaintances may be more valuable. Weak ties not only help disseminate unique information which a user may not otherwise have access to, but also improve organization-wide networking and benefit employees' career growth.

In the example of FIG. 5, data analytics engine 404 performs a two-tier filter to filter out potential meeting participants based on proximity and diversity. Data analytics engine 404 first generates a proximity score table, e.g., table 506 in FIG. 5, for each employee (e.g., employees 1 to 50,000). Each entry of table 506 includes a proximity score between the employee with another employee. The proximity score may be in a continuous range with bound limits (e.g., 0-1), where a higher score value represents a higher tie strength. For example, people having everyday contact will have very strong strength and a high proximity score.

Since there is no need to improve the strong ties between people that already have considerable interactions, data analytics engine 404 identifies weak-tie users of each employee as candidate meeting connections of the employee. For example, data analytics engine 404 generates a list 508 of connections for employee 1 from table 506, each connection having a middle-ranged proximity score with employee 1. In some embodiments, data analytics engine 404 removes high proximity connections in table 506 (e.g., top 20% of connections) from the list 508 of connections for employee 1. Data analytics engine 404 also eliminates low proximity connections in table 506 (e.g., bottom connections with zero or close-to-zero ties) from list 508. By removing the top and bottom connections (e.g., high and low proximity people), data analytics engine 404 leaves only weak-tie connections (e.g., 60% of all connections) in list 508 for the next step filtering. In some embodiments, data analytics engine 404 may specify one or more thresholds to determine the boundary proximity scores (e.g., lower limit/percentage and/or upper limit/percentage) for weak ties.

In some embodiments, data analytics engine 404 performs weak-tie filtering to determine weak-ties based on proximity using one or more ML models. Instead of cutting off the top A% ties and bottom B% ties and leaving the middle C% ties as candidate meeting connections, data analytics engine 404 may train the one or more ML models using the user activity data, user scoring data, and other data to determine the range of connections (e.g., weak ties) in list 508. For example, employee 1 may cooperate and frequently interact with a team on a project to derive high proximity scores. When learning a status change (e.g., detecting that employee 1 no longer works with the team), data analytics engine 404 may reduce the number of team members that are removed from list 508 in the prediction of the incoming interaction drops with the team. In another example, when rescheduling a meeting responsive to employee l′s request, data analytics engine 404 may also change the weak tie in list 508. In some embodiments, the one or more models may be a logistic regression model, a support vector machine (SVM) model, a cluster model, etc.

Data analytics engine 404 may further determines weak ties by training the one or more models using activity data received from various sources such as Microsoft office® 365, social networking applications, or other types of applications. For example, Microsoft Outlook® may show that a user meaningfully corresponded with employee 1 in a period of time and stopped the communication with employee 1, data analytics engine 404 may identify this user as a weak-tie user for potentially meeting with employee 1 to improve the connection between employee 1 and this user. Similarly, employee 1 may lose contact with an old friend that has been listed on his/her LinkedIn for a long time. Instead of removing this friend from list 508 because of the close-to-zero proximity score caused by the absence of interactions, data analytics engine 404 may also identify this user as a weak-tie user for purpose of scheduling a catch-up meeting.

Once the weak ties in list 508 are determined based on learning from proximity scores, user activities, and user preferences, data analytics engine 404 moves to further filter the connections of list 508 by a diversity preference of employee 1 to generate a diversity filter list/result 510. Employee 1 working in one team would not have a high diversity score with other employees working in the same team. However, employee 1 may have a high diversity score with another employee in a different team, where the diversity score reflects how diverse one team might be relative to another team. Employee 1 can choose to meet with people having high, middle, or low diversity levels, e.g., as depicted below in FIG. 7C. For example, employee 1 seeking changes may choose a high diversity level. Responsive to this preference, data analytics engine 404 may remove the low diversity users from the bottom part of list 508 to generate filter list 510. As a result, data analytics engine 404 may connect employee 1 with people who are very distant in the networking from employee 1. Data analytics engine 404 analyzes the diversity preference of employee 1, and includes the connections with the preferred diversity level in diversity filter result 510, e.g., in an order of high to low diversity. In some embodiments, data analytics engine 404 may specify one or more thresholds to determine the boundary diversity scores (e.g., lower limit/percentage and/or upper limit/percentage) based on user preferences for diversity.

Employee 1 can change preference settings anytime, and data analytics engine 404 can dynamically adjust candidate meeting connections in filter result 510 in real time. Similarly, when the proximity score or diversity score is changed based on user activities, or employee 1 provides feedback (e.g., de-selecting a person with whom employee 1 does not want to get paired with), data analytics engine 404 can also dynamically adjust filter result 510 to accommodate the changes.

Although the example of FIG. 5 shows filtering users to determine meeting pairs based on proximity and diversity, a person skilled in the art should recognize that other factors such as centrality can also be used in such filtering and determination. For example, data analytics engine 404 may use a centrality score to avoid overweighing users with centrality and, instead, improve networks for users who lack centrality such as a new hire who is not a complete stranger but is also not well-connected.

When user filtering based on proximity, diversity or other factors is performed, and candidate meeting connections are generated for a user, suggestion module 406 may determine one or more matched users from the candidate meeting connections and schedule a meeting with the matched users. As shown in FIG. 5, list 512 including candidate meeting connections for employee 1, list 514 including candidate meeting connections for employee 2, and/or other lists for other employees can be generated by data analytics module 404. In some embodiments, suggestion module 406 compares employee 1's connection list 512 against employee 2's connection list 514 to determine whether employee 1 is on employee 2's connection list. Suggestion module 406 determines a match if employee 2 is the top connection for employee 1. Responsive to determining that employees 1 and 2 match, suggestion module 406 searches calendars 516 of employee 1 and employee 2 to find a common time slot for a meeting. In some embodiments, suggestion module 406 may find match slots according to user preferences. For example, a user sets a preference for two meetings a week. If two meetings have been scheduled for the user in a week, the user is not available even if his/her calendar shows that there are available slots in the week.

Suggestion module 406 may determine a common slot randomly or in a sequence. For example, suggestion module 406 determines a common slot in a first week. If there is no available slot in the first week, suggestion module 406 skips to the second week, and then skips to the next week until a common slot is found. In some embodiments, suggestion module 406 may specify a threshold attempt number. Once the number of attempts to find a slot that is available for both employee 1 and employee 2 exceeds the threshold attempt number, suggestion module 406 may determine that employee 1 and employee 2 do not have a slot in common. In such a scenario, suggestion module 406 may resume the comparison between list 512 and 514 to determine a next match for employee 1, that is, finding the connection (e.g., employee 3) after employee 2 on list 512 for employee 1.

In some embodiments, suggestion module 406 may schedule a meeting using a scheduling application such as Calendly® or Microsoft Outlook® calendar. An example Outlook® calendaring “made easy by outlook” 650 is shown in FIG. 6B. In some embodiments, when Outlook® application is running on a computing device associated with a user (e.g., employee 1), the availability status of this user can be automatically determined and presented to his/her meeting connection (e.g., employee 2) to facilitate the meeting scheduling and reduce manual operational errors. In other embodiments, software application 302 residing on user device 304 (e.g., a connect bot application 702 as described in FIGS. 7A-7K) can substitute Outlook® application to implement the calendaring function shown in FIG. 6B to present user availability status regardless of whether Outlook® is used.

As shown in FIG. 5, once a common slot between employee 1 and employee 2 is determined, suggestion module 406 generates a meeting suggestion between these users at the determined time slot and notifies the users of this meeting suggestion. In some embodiments, suggestion module 406 sends an introductory e-mail with a video conferencing link for employee 1 and employee 2 to meet at the determined time slot. A person skilled in the art should recognize that other types of notification (e.g., an interactive prompt, a voice message) of the suggested meeting can be sent to meeting participants.

In some embodiments, when a meeting suggestion is sent to users (e.g., employees), connect tracker 408 is activated to track the progress of the meeting. Connect tracker 408 may also determine new data from the tracking and feed the new data into one or more ML models to improve the meeting suggestion generation. As the user data changes over time, in some embodiments, connect tracker 408 captures these changes and communicates with other modules (e.g., suggestion module 406) to update the meeting suggestion accordingly. For example, connect tracker 408 may detect that user 306 changes the preference for meeting frequency, and causes the next meeting to be generated according to the new frequency. In another example, connect tracker 408 tracks how many meetings are accepted and declined by each employee and feeds this information to the one or more models to modify the meeting suggestions to increase the acceptance rate of the suggested meetings.

In other embodiments, connect tracker 408 may also retrieve the data related to meeting progress (e.g., user acceptance/rejection/rescheduling, user preference changes) periodically and use this data to improve the meeting suggestion generation. For example, connect tracker may work with Analyzer 504 to upgrade a proximity score for an employee after determining the strengthening of weak ties over time due to accepting and conducting the suggested meetings with others.

User interface module 410 may communicate with other modules/engines of server 320 to generate and transmit graphic data to user device 304 associated with user 306 for displaying, on user device 304, graphical representations related to meeting suggestion generation, e.g., as shown FIGS. 7A-7K and FIGS. 8A-8B. In some embodiments, user interface module 410 generates user interfaces in a form of card. For example, user interface module 410 may provide one or more cards when a user joins the connect bot application, when the user takes a tour to know more about the connect bot application, or during the onboarding when the user configures preferences, etc. In other embodiments, user interface module 410 also generates user interfaces in other forms to implement the functionalities described herein.

### Self-Meeting Suggestion Generation

As foregoing discussed, the present disclosure can improve networking among users (e.g., employees) by identifying meeting connections for a user and scheduling a meeting based on at least one of the measurements of proximity, diversity, and network centrality as well as user preferences (e.g., on frequency and diversity). However, rather than connecting with others, sometimes a user may want to reserve certain time slots for himself/herself for learning, relaxing or other purposes. The present disclosure accommodates this need with a “coffee with me” feature, which is described in detail in FIGS. 8A and 8B.

In some embodiments, a user (e.g., user 306) may request to schedule a meeting by opening software application 302 and/or configuring user preferences on a set of attributes. The set of attributes includes meeting frequency, maximum duration, maximum total amount, earliest time, latest time, etc. Responsive to receiving the user preferences (e.g., five hours learning in one month), suggestion module 406 may identify free time slots for user 306. Suggestion module 406 finds appropriate slots in the user's calendar for user 306 to achieve a goal, without considering the network attributes/measurements such as proximity, diversity, or network centrality.

In other embodiments, suggestion module 406 may extend the one-person meeting to a group meeting based on factors including user interests, network measurements, etc. Suggestion module 406 may instruct user interface module 410 to generate a user interface to receive user 306's preference on a group meeting. For example, for user 306 intending to have a training class on a subject with a certain frequency, suggestion module 406 may prompt user 306 (e.g., via a user interface) to confirm that the user is willing to participate in a group class. Suggestion module 406 may communicate with data aggregation module 402, data analytics engine 404 and/or other modules/engines of connect bot component 322 to identify other users who are also interested in the subject, determine one or more common slots based on user 306 and other users' preferences, and schedule a meeting between the identified users at the determined slot(s). When creating the training class with others, user 306's preferences for the proximity, diversity and/or centrality can also be considered. The scheduling process and algorithms are similar as discussed above, and thus will not be repeated herein.

### User Interfaces

As described above, server 320 (e.g., user interface module 412) may communicate with user device 304 via software application 302 to implement a connect bot solution that automatically provides user interfaces on user device 304 to enable a meeting suggestion generation process and help a suggested meeting to be conducted between users. FIGS. 7A-7K illustrate exemplary user interfaces of streamlining a meeting suggestion generation process, according to some embodiments. Unless specified otherwise, user interfaces in FIGS. 7A-7K are implemented on a Microsoft Teams® platform. However, a person skilled in the art should recognize similar interfaces may also be integrated and generated on other virtual meeting platforms such as Zoom®, Webex®, etc.

In some embodiments, a user-side connect bot application (e.g., software application 302) residing on user device 304 communicates with connect bot component 322 residing on server 320 and other components of system 300 to implement the connect bot solution. For example, when user 306 opens software application 302 installed on associated user device 304, a welcome user interface or welcome card 700 of FIG. 7A is presented to user 306. This card indicates that a connect bot solution (i.e., connect bot 702) may be used to help user 306 to set up a meeting with randomly paired people based on user 306's preferences. Card 700 includes default preferences 704, and also indicates that user 306 can take a tour and set preferences of connect bot solution 702 through tabs 706 and 708, respectively. In some embodiments, if user 306 takes the default preferences or selects tab 706, a user interface in FIG. 7B will be populated to allow the user to take a tour about connect bot solution 702.

User 306 can take a tour through adaptive cards in a carousel. FIG. 7B includes four example cards 710, 712, 714 and 716, which can be switched back and forth by user 306 selecting buttons 711a and/or 711b. As indicated in first card 710, connect bot 702 can schedule a meeting automatically between users as per the user's preferences. In some embodiments, by default, the connect bot application/solution is deactivated to protect any users' preferences and private information. User 306 may be presented with another card (not shown) to choose not to opt-in or activate this solution/application. The second card 712 is related to user preferences, where user 306 may be shown how to flexibly choose a meeting/catch-up frequency, a diversity level of matching, etc. The third card 714 is about silent days and skipping people, which shows that user 306 may mark certain days of a week as “silent days” on which no user meetings will be scheduled. The optional feature of skipping people allows user 306 to add people to a skip list, of which the users will not be matched to user 306. Once the tour is complete, user 306 can use a “Preference” option 718 in the fourth card 716 to start preference configuration.

FIG. 7C shows a user interface 722 including tabs for user 306 setting preferences 722 and view a matched list 724. For example, user 306 can choose whether to pause all matches, view a detailed notification, and configure the values of frequency, silent days, diversity level, working hours, etc. The matched list includes one or more upcoming matches and skipped people. In user interface 726 of FIG. 7D, user 306 can set “pause all matches” to true as indicated in 727 when user 306 does not want to consider matching and receiving a meeting suggestion/schedule. As a result, no meeting will be scheduled if user 306 confirms the pausing of all matches in dialog 728. The match provision is paused temporarily for user 306 and can be resumed later based on an update of the preferences. FIG. 7E includes a view 730 of a matched list. In some embodiments, when user 306 views the upcoming matches in the matched list and hovers on a name, a “Skip” option will appear to allow user 306 to add the name to a skipped list. User 306 will not have a meeting with the user of this name. Later, when user 306 views the skipped list and hovers on the name, he/she may be provided an option to add the name back to the upcoming match list so user 306 may communicate with this specific user again. User 306 may receive a notification shown in a distinctive location of the user interface 730, indicating one name being added to the matched list. User 306 may further search and filter the matched list.

FIG. 7F includes adaptive cards showing multiple notifications. Notification 732 tells user 306 and/or the matched user a meeting is scheduled between them. Notification 732 also includes options for a user to take action such as “Reject” 733 or “Find other slots” 734. In some embodiments, notification 732 is provided to a user only if the user has opted for “detailed notifications” in FIG. 7C.

When user 306 or his/her matched user (i.e., DM) selects “Reject” 733, a notification is always generated to notify the other user(s) of the rejection. Reject notification 736 indicates that a matched user DM has rejected the meeting with user 306. Notification 736 also includes a reason for the rejection. In some embodiments, the rejecting user can provide, in another adaptive card (not shown), a reason explaining the rejection. In some embodiments, when a user rejects the meeting, the meeting will be automatically rescheduled for a limited number of times (e.g., one time). For example, notification 738 shows that a meeting is automatically rescheduled to another available time slot. If user 306 and/or matched user reject the meeting again, in some embodiments, automatic reschedule is no longer available. However, a user can always select “Find other slots” 734 included in notification 732 to manually adjust a meeting schedule.

FIG. 7G shows a bot command card 740 for viewing, setting or resetting preferences or a matched list. As shown in card 740, when preference option 741 is selected, a card 742 appears for user 306 to view the preferences and/or update the preferences by selecting an “Update Preference” tab 743 to redirect to preference configuration as shown in FIG. 7C.

Once a meeting is scheduled, it is added to the calendar of a virtual conference system. This virtual conference system provides the meeting platform for user 306 and other users to conduct a virtual/online meeting. In user interface 746 of FIG. 7H, a connect bot meeting 747 is added to a Teams® calendar. It should be known this can also be a calendar event in Zoom®, Webex®, etc. In some embodiments, an email notification 748 of a scheduled meeting is also sent to the meeting participants. The email notification may include the meeting details along with the participants required.

FIG. 7I shows user interfaces 750 and 754 including Teams® calendar. User interface 750 includes options 751 and 752 for user 306 to join, chat, confirm and/or respond to a meeting invitation. Prior to joining the meeting, user 306 may review meeting details along with the participants list in Teams® calendar. User 306 may also chat with the participant prior to joining or responding to the invitation using option 755 in user interface 754.

FIG. 7J includes a reminder notification 760 in an adaptive card that is presented to meeting participants 15 minutes prior to a scheduled meeting starts. In some embodiments, this notification is generated only if a user has chosen “detailed notifications” in FIG. 7C, and the time window to set out a reminder (e.g., 15 minutes) is configurable. FIG. 7J also includes a user interface 762 showing a pre-meeting experience for user 306 to help the user remember a previous encounter with a specific user.

A meeting can be conducted. Before the end of the meeting, a meeting feedback diagram as shown in user interface 770 of FIG. 7K may be presented to meeting participants included in side panel 771. A participant can provide feedback as shown in user interface 772 of FIG. 7K. The feedback from the meeting participants will then be used, e.g., to train one or more ML models, to improve the accuracy and efficiency of meeting suggestions.

FIGS. 8A and 8B illustrate exemplary user interfaces related to a “Coffee with me” feature of a connect bot solution (e.g., connect bot 702 shown in FIGS. 7A-7K). In some embodiments, a “Coffee with me” feature enables a connect bot to schedule an appointment for users (e.g., employees) such that the users can perform certain tasks (e.g., enterprise learning), based on the users' preferences configured in the connect bot solution and the users' availability as reflected in a calendar (e.g., a Microsoft Teams® calendar). Similar to FIGS. 7A-7K, although user interfaces in FIGS. 8A-8C are depicted in Microsoft Teams® environment, these interfaces can also be generated in other virtual meeting platforms such as Zoom®, Webex®.

FIG. 8A shows a welcome card 800 generated for a user (e.g., user 306) that has installed the connect bot application (e.g., connect bot 702). This adaptive card, similar in the form to the “take the tour” card shown in FIG. 7B., explains the “Coffee with me” feature with text such as “Would you like to be reminded when you have time to learn, so that you don't forget? Coffee with ME is here for you! It protects calendar timeslots when you have the most availability, based on the preferences you set.” Welcome card 800 also includes a “set preference” option 802 for user 306 to configure his/her preferences. FIG. 8A further includes a different welcome card 810 for a new user, which notifies the new user to sign up for “Coffee with me.” Once the new user installs the connect bot application, welcome card 800 will then be presented to the user.

Upon user 306 clicking “set preference” option 802, in some embodiments, user interface 820 shown in FIG. 8B is generated and presented to user 306. With this interface, user 306 can use switch 822 to turn on/enable the “Coffee with me” feature, which is off by default. Once user 306 turns on this feature, the frequency, time duration, silent days and/or other parameters of “Coffee with me” feature can be configured in user interface 820 and get updated with option 824.

Responsive to receiving preference configuration and determining the calendar availability of user 306, a Calendar meeting can be created for user 306. In some embodiments, an adaptive card can be sent to user 306 as a reminder at a fixed interval, e.g., every 15 days. The specific interval is determined depending on user 306's preference. If user 306 needs to delete this meeting appointment, user 306 would be presented with an option to cancel the appointment through the connect bot application. Such a user action can be monitored and tracked, and stored in a database. An email including guidance to cancel the appointment can also be sent to user 306. In some embodiments, user 306 may also delete the appointment from the corresponding calendar (e.g., Microsoft Teams calendar). In other embodiments, based on the monitoring of user actions, a “coffee with me” meeting can be automatically rescehuled, and a notification can be sent to the user for confirming or rejecting the rescehuled meeting. The user actions can be a preference change, for example, the user no longer needs a weekly meeting. The user actions can also be a calendar event change.

### Meeting Suggestion Generation Methods

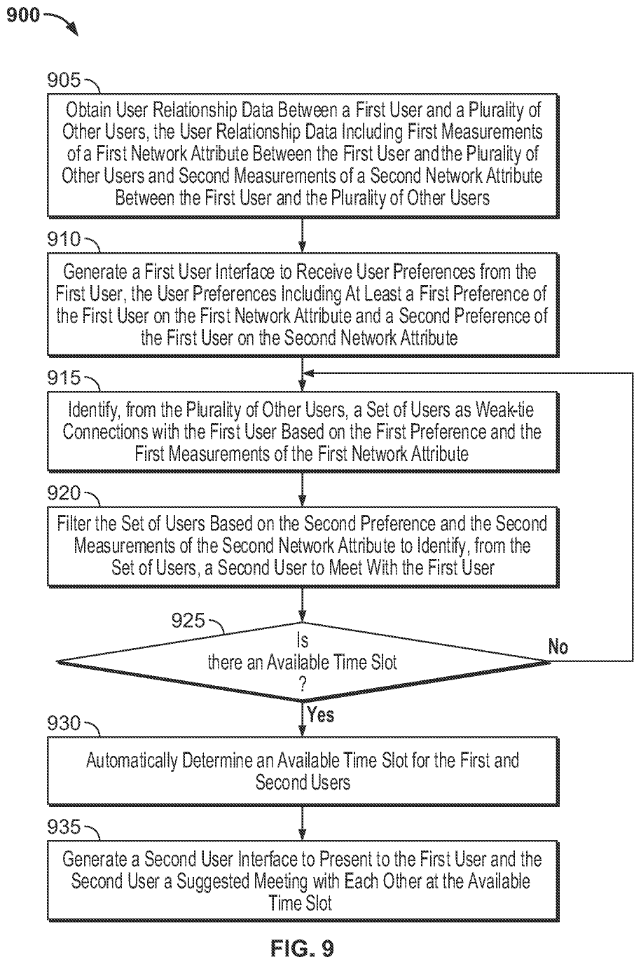

FIG. 9 illustrates an exemplary method 900 for intelligently generating a meeting suggestion for a first user and another user, according to some embodiments. In some embodiments, connect bot component 322 of server 320 as depicted in FIG. 4 communicates with other components of system 300 to implement method 900. At operation 905, connect bot component 322 obtains user relationship data between a first user and a plurality of other users, the user relationship data including first measurements of a first network attribute between the first user and the plurality of other users and second measurements of a second network attribute between the first user and the plurality of other users. In some embodiments, the first network attribute is a strength of relationship between the first user and each of the plurality of other users and the first measurement of the first network attribute is a proximity score reflecting. The second network attribute is a diversity level between the first user and each of the plurality of other users and the second measurement of the second network attribute is a diversity score. In other embodiments, the user relationship data may also include a third measurement of a third network attribute. The third network attribute can be a centrality of the first user and the third measurement of the third attribute can be a centrality score. The user relationship data is used to determine a meeting suggestion for the first user.

At operation 910, connect bot component 322 generates a first user interface to receive user preferences from the first user. The user preferences may include at least a first preference of the first user on the first network attribute and a second preference of the first user on the second network attribute. For example, the first user may choose to meet with people with low proximity and high diversity.

At operation 915, connect bot component 322 identifies, from the plurality of other users, a set of users as weak-tie connections with the first user based on the first preference and the first measurements of the first network attribute. For example, connect bot component 322 may take a middle range of the first measurements and determine the set of users having the first measurements falling within the range as the weak-tie connections. In some embodiments, connect bot component 322 may determine the range of the first measurements based on one or more machine learning models trained using user relationship data, user preference data, user demographical data, and other data.

At operation 920, connect bot component 322 filters the set of users based on the second preference and the second measurements on the second network attribute to identify, from the set of users, a second user to meet with the first user. For example, based on user filtering using the second network attribute, the first user may be able to meet with a second user that is distant or diverse in the network from the first user.

At operation 925, connect bot component 322 automatically determines whether there is a common time slot for both the first and second users, e.g., based on accessing and comparing calendar events in the calendars of the first and second users according to user preferences. Upon determining an available time slot at operation 930, connect bot component 322 may generate a second user interface to present to the first user and the second user a suggested meeting with the each other at the available time slot at operation 935. However, if there is no available time slot, method 900 will return back to operation 915, where connect bot component 322 will identify a new second user to be paired with the first user for a meeting.

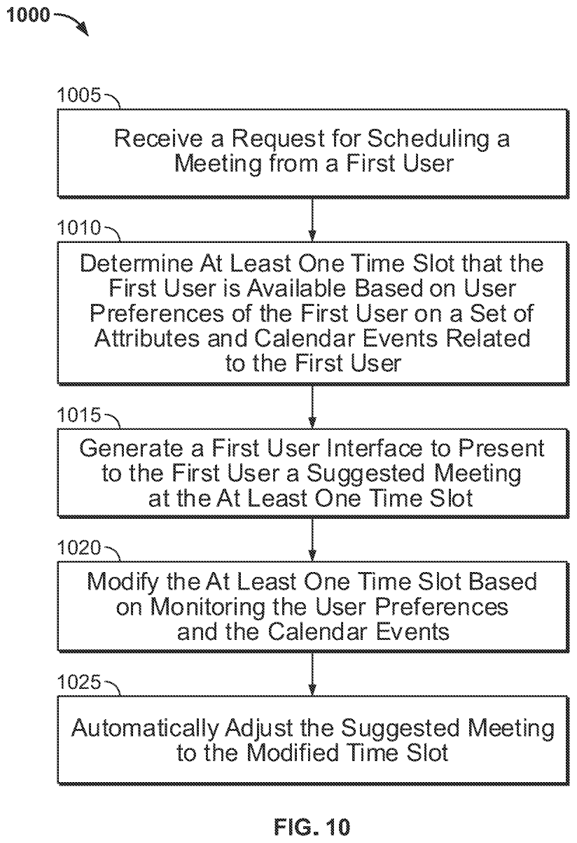

FIG. 10 illustrates an exemplary method 1000 for intelligently generating a meeting suggestion for a user, according to some embodiments. In some embodiments, connect bot component 322 of server 320 as depicted in FIG. 4 communicates with other components of system 300 to implement method 1000. In some embodiments, method 1000 relates to “coffee with me” feature as depicted in FIGS. 8A-8B. At operation 1005, connect bot component 322 receives a request for scheduling a meeting for a first user. For example, the first user may open software application 302 and configure the user preference related to meeting scheduling. This signals that the first user is requesting a meeting assignment. This meeting assignment is for the first user to learn, relax, or achieve other goals. In some embodiments, the set of attributes includes at least one or more meeting frequency, maximum duration, maximum total amount, earliest time, or latest time.

At operation 1010, connect bot component 322 determines at least one time slot that the first user is available based on user preferences of the first user on a set of attributes and calendar events related to the first user. At operation 1015, connect bot component 322 generates a first user interface to present to the first user a suggested meeting at the at least one time slot. At operation 1020, connect bot component 322 modifies the at least one time slot based on monitoring the user preferences and the calendar events. At operation 1025, connect bot component 322 automatically adjusts the suggested meeting to the modified time slot.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated and described with the figures above. Modules may constitute either software modules (e.g., code embodied on a machine-readable medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processors) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that includes a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” is employed to describe elements and components of the embodiments herein. This is done merely for convenience and to give a general sense of the claimed invention. This description should be read to include one or at least one and the singular also includes the plural unless it is obvious that it is meant otherwise.

Upon reading this disclosure, those of skill in the art will appreciate still additional alternative structural and functional designs for the system described above. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for intelligently generating a meeting suggestion and automatically adapting meeting interfaces to improve weak-tie connections, the computer-implemented method comprising:
obtaining user relationship data between a first user and a plurality of other users, the user relationship data including first measurements of a first network attribute between the first user and the plurality of other users and second measurements of a second network attribute between the first user and the plurality of other users;
generating a first user interface to receive user preferences from the first user, the user preferences including at least a first preference of the first user on the first network attribute and a second preference of the first user on the second network attribute;
identifying, from the plurality of other users, a set of users as weak-tie connections with the first user based on the first preference and the first measurements of the first network attribute;
filtering the set of users based on the second preference and the second measurements of the second network attribute to determine, from the set of users, a second user to meet with the first user;
automatically determining an available time slot for the first and second users; and
generating a second user interface to present to the first user and the second user a suggested meeting with each other at the available time slot.

2. The computer-implemented method of claim 1, wherein the first network attribute is a strength of relationship between the first user and each of the plurality of other users and the first measurement of the first network attribute is a proximity score, and wherein the second network attribute is a diversity level between the first user and each of the plurality of other users and the second measurement of the second network attribute is a diversity score.

3. The computer-implemented method of claim 1, wherein:
the user relationship data includes a third measurement of a third network attribute,
the third network attribute is a centrality of the first user and the third measurement of the third attribute is a centrality score, and
filtering the set of users is further based on a third preference of the first user on the third network attribute.

4. The computer-implemented method of claim 1, further comprising:
determining a range of the first measurements indicating weak ties with the first user; and
identifying the set of users having the first measurements falling within the range as the weak-tie connections with the first user.

5. The computer-implemented method of claim 4, wherein determining the range of the first measurements is based on one or more machine learning models trained using user relationship data, user preference data, user demographical data, or other data.

6. The computer-implemented method of claim 1, wherein the user relationship data is determined based on user activity data from heterogeneous sources, the heterogeneous sources including at least a Microsoft office application, a social network application, or other types of applications.

7. The computer-implemented method of claim 1, wherein the user preferences further comprise choices of the first user on meeting frequency, silent days, working hours, or other attributes, wherein determining the available time slot comprises:
accessing calendars of the first and second users; and
comparing calendar events in the calendars based on the user preferences to determine the available time slot for both the first user and the second user.

8. The computer-implemented method of claim 1, further comprising:
tracking progress of the suggested meeting;
receiving user feedback to the suggested meeting, the user feedback including at least one of accepting, rejecting, or rescheduling the suggested meeting; and
training one or more models based on the user feedback to adjust subsequent meeting suggestions.

9. The computer-implemented method of claim 1, wherein at least one of the first user interface or the second user interface is displayed in a form of a card.

10. A system for intelligently generating a meeting suggestion and automatically adapting meeting interfaces to improve weak-tie connections, the system comprising:
a processor; and
a memory in communication with the processor and comprising instructions which, when executed by the processor, program the processor to:
obtain user relationship data between a first user and a plurality of other users, the user relationship data including first measurements of a first network attribute between the first user and the plurality of other users and second measurements of a second network attribute between the first user and the plurality of other users;
generate a first user interface to receive user preferences from the first user, the user preferences including at least a first preference of the first user on the first network attribute and a second preference of the first user on the second network attribute;
identify, from the plurality of other users, a set of users as weak-tie connections with the first user based on the first preference and the first measurements of the first network attribute;
filter the set of users based on the second preference and the second measurements of the second network attribute to determine, from the set of users, a second user to meet with the first user;
automatically determine an available time slot for the first and second users; and
generate a second user interface to present to the first user and the second user a suggested meeting with each other at the available time slot.

11. The system of claim 10, wherein the first network attribute is a strength of relationship between the first user and each of the plurality of other users and the first measurement of the first network attribute is a proximity score, and wherein the second network attribute is a diversity level between the first user and each of the plurality of other users and the second measurement of the second network attribute is a diversity score.

12. The system of claim 10, wherein:
the user relationship data includes a third measurement of a third network attribute,
the third network attribute is a centrality of the first user and the third measurement of the third attribute is a centrality score, and
filtering the set of users is further based on a user preference on the third network attribute to identify the second user.

13. The system of claim 10, wherein the instructions further program the processor to:
determine a range of the first measurements indicating weak ties with the first user; and
identify the set of users having the first measurements falling within the range as the weak-tie connections with the first user.

14. The system of claim 13, wherein determining the range of the first measurements is based on one or more machine learning models trained using user relationship data, user preference data, user demographical data, or other data.

15. The system of claim 10, wherein the user relationship data is determined based on user activity data from heterogeneous sources, the heterogeneous sources including at least a Microsoft office application, a social network application, or other types of applications.

16. The system of claim 10, wherein the user preferences further comprise choices of the first user on meeting frequency, silent days, working hours, or other attributes, and wherein, to determine the available time slot, the instructions further program the processor to:
access calendars of the first and second users; and
compare calendar events in the calendars based on the user preferences to determine the available time for both the first user and the second user.

17. The system of claim 10, wherein the instructions further program the processor to:
track progress of the suggested meeting;
receive user feedback to the suggested meeting, the user feedback including at least one of accepting, rejecting, or rescheduling the suggested meeting; and
train one or more models based on the user feedback to adjust subsequent meeting suggestions.

18. The system of claim 10, wherein at least one of the first user interface or the second user interface is displayed in a form of a card.

19. A computer program product for handling unlabeled interaction data with contextual understanding, the computer program product comprising a non-transitory computer-readable medium having computer readable program code stored thereon, the computer readable program code configured to:
obtain user relationship data between a first user and a plurality of other users, the user relationship data including first measurements of a first network attribute between the first user and the plurality of other users and second measurements of a second network attribute between the first user and the plurality of other users;
generate a first user interface to receive user preferences from the first user, the user preferences including at least a first preference of the first user on the first network attribute and a second preference of the first user on the second network attribute;
identify, from the plurality of other users, a set of users as weak-tie connections with the first user based on the first preference and the first measurements of the first network attribute;
filter the set of users based on the second preference and the second measurements of the second network attribute to determine, from the set of users, a second user to meet with the first user;
automatically determine an available time slot for the first and second users; and
generate a second user interface to present to the first user and the second user a suggested meeting with each other at the available time slot.

20. The computer program product of claim 19, wherein the first network attribute is a strength of relationship between the first user and each of the plurality of other users and the first measurement of the first network attribute is a proximity score, and wherein the second network attribute is a diversity level between the first user and each of the plurality of other users and the second measurement of the second network attribute is a diversity score.
